(19) United States
(12) Patent Application Publication
(10) Pub. No.: US 2026/0034469 A1
(43) Pub. Date: Feb. 5, 2026

(54) MODEL ROCKET LAUNCHER WITH INTERACTIVE REMOTE LAUNCH FEATURES

(71) Applicant: Langford Industries, LLC, Falls Church, VA (US)

(72) Inventors: John Langford, Falls Church, VA (US); Robert Langford, Penrose, CO (US); Kyle Giunta, North Chelmsford, MA (US); Steve Owens, Litchfield, NH (US); Mike Varanka, Amherst, NH (US); James LeFave, Wilmington, MA (US)

(73) Assignee: Langford Industries, LLC, Falls Church, VA (US)

(21) Appl. No.: 18/942,763

(22) Filed: Nov. 10, 2024

Related U.S. Application Data
(60) Provisional application No. 63/679,030, filed on Aug. 2, 2024.
(60) Provisional application No. 63/711,118, filed on Oct. 23, 2024.

(51) Int. Cl. A63H 27/14

(52) U.S. Cl. CPC A63H 27/14

(57) ABSTRACT

A wireless model rocket launcher and rocket which provide for safety checking and advanced functionality to be performed wirelessly using a mobile communication device such as a cell phone. A set of safety checks can be performed before the rocket is armed and triggered for launch. In addition, a location of the rocket can be tracked wirelessly on the mobile communication device.

### CROSS REFERENCE TO RELATED APPLICATIONS

This application claims benefit to U.S. provisional application 63/679,030, which is incorporated by reference herein in its entirety for all purposes. This application also claims benefit to U.S. provisional application 63/711,118, which is incorporated by reference herein in its entirety for all purposes.

### BACKGROUND OF THE INVENTION

### Field of the Invention

The present general inventive concept is directed to a method, apparatus, and computer readable storage medium directed to a model rocket launching system.

### Description of the Related Art

Model rocketry has been a popular hobby for over 50 years. In the past, model rockets were launched using an electrical ignition system with a remote control which would apply current using a switch thereby igniting a rocket engine.

A model rocket first has its engine ignited which causes thrust to accelerate the rocket upwards. Then the rocket would coast in the air as a result of its kinetic energy. When the rocket reaches its peak altitude, the rocket's nose cone would automatically open and its parachute would deploy. The rocket would then coast down to earth via its parachute, although its landing position might be far away which could cause the rocket to be lost.

### SUMMARY OF THE INVENTION

It is an aspect of the present invention to provide an improved rocket launching system and cloud support services.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is drawing illustrating a rocket engine with an igniter inserted therein, according to an embodiment;

FIG. 2 is a drawing illustrating a launcher with a key not inserted, according to an embodiment;

FIG. 3 is a drawing illustrated a launcher with the key inserted therein, according to an embodiment.

FIG. 4 is a drawing of a housing of a launcher, according to an embodiment;

FIG. 5 is a drawing of a blast deflector of a launcher, according to embodiment;

FIG. 6 is a further drawing of the blast deflector, according to an embodiment;

FIG. 7 is a drawing of an enclosure for a launcher, according to an embodiment;

FIG. 8 is a drawing of a battery lid for a battery for the launcher, according to an embodiment;

FIG. 9 is a drawing of a printed circuit board for the launcher, according to an embodiment;

FIG. 10 is a block diagram of the electronics for the launcher, according to an embodiment;

FIG. 11 is a block diagram illustrating power modules for the launcher, according to an embodiment;

FIG. 12 are circuit diagrams for various aspects of the launcher, according to an embodiment;

FIG. 13 are additional circuit diagrams for various aspects of the launcher, according to an embodiment;

FIG. 14 is a drawing of light pipes and shorting connectors for the launcher, according to an embodiment;

FIG. 15 is a flowchart illustrating a first sequence of an exemplary method of implementing launching a model rocket, according to an embodiment;

FIG. 16 is a flowchart illustrating a further sequence of an exemplary method of implementing launching a model rocket, according to an embodiment;

FIG. 17 is a flowchart illustrating a method to determine whether a launchpad is in safe proximity from a user, according to an embodiment;

FIG. 18 is a block diagram illustrating a computer communications network, according to an embodiment;

FIG. 19 is a block diagram illustrating computing hardware to implement a portable device, according to an embodiment;

FIG. 20 is a flowchart illustrating an exemplary method of utilizing a physical hardware key to unlock a rocket, according to an embodiment;

FIG. 21 is a flowchart illustrating an exemplary method to store launch data in a cloud-server, according to an embodiment;

FIG. 22 is a flowchart illustrating an exemplary method to automatically suggest to a user to purchase engines when the is low on supply, according to an embodiment;

FIG. 23 is a flowchart illustrating an exemplary method of publishing assets related to launches to a user's social network, according to an embodiment;

FIG. 24 is a set of screen shots showing example pairing messages, according to an embodiment;

FIG. 25 is a set of screen shots showing example volume control messages, according to an embodiment;

FIG. 26 is a set of screen shots showing example safety messages, according to an embodiment;

FIG. 27 is a set of screen shots showing example safety check swipes, according to an embodiment;

FIG. 28 is a set of screen shots showing example launch messages, according to an embodiment;

FIG. 29 is a screen shot showing an example of a final launch message, according to an embodiment;

FIG. 30 is a set of screen shots showing launch status messages, according to an embodiment;

FIG. 31 is a set of screen shots showing launch error messages, according to an embodiment;

FIG. 32 is a flowchart illustrating an exemplary method of implementing a rocket launch, according to an embodiment;

FIG. 33 is a flowchart illustrating an exemplary method of performing a ready check, according to an embodiment;

FIG. 34 is a flowchart illustrating an exemplary method of performing an arming check, according to an embodiment;

FIG. 35 is a flowchart illustrating an exemplary method of post launch checks, according to an embodiment;

FIG. 36 is a block diagram illustrating electronic hardware comprising a launcher, according to an embodiment;

FIG. 37 is a block diagram illustrating electronic hardware located inside the rocket itself, according to an embodiment;

FIG. 38 is a flowchart illustrating an exemplary method of transmitting positional and sensor data from a rocket, according to an embodiment;

FIG. 39 is a flowchart illustrating an exemplary method of generating and posting media clips, according to an embodiment;

FIG. 40 is a flowchart illustrating an exemplary method of generating suggested purchases, according to an embodiment;

FIG. 41 is a drawing of a sample screen of a mobile device displaying a suggested purchase, according to an embodiment;

FIG. 42 is a drawing of a sample screen of a mobile device displaying a media clip, according to an embodiment;

FIG. 43 is a drawing of a sample screen of mobile device displaying a review of a launch site, according to an embodiment;

FIG. 44 is a flowchart illustrating an exemplary method of receiving reviews of launch sites, according to an embodiment;

FIG. 45 is a flowchart illustrating an exemplary method of suggestion launch sites, according to an embodiment;

FIG. 46 is a drawing of a sample screen displaying suggested launch sites, according to an embodiment;

FIG. 47 is a flowchart illustrated an exemplary method of storing flight data across multiple launches, according to an embodiment;

FIG. 48 is a flowchart illustrating an exemplary method of utilizing multiple flight data, according to an embodiment; and

FIG. 49 is a drawing of a sample output of a leaderboard showing highest altitudes, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

Embodiments of the present invention include a Bluetooth-enabled launch controller/pad/rocket which can reduce launcher cost by eliminating wire, keys, etc. A mobile based app can serve as a launch controller. A portal can allow users to download software/apps and log in, which can track customers and launches. A sales portal can track actual product use. The rocket can include an onboard data logger which can log acceleration, velocity, trajectory, temperature, pressure, GPS location, video, and sound, etc. After the flight, there can be post-flight downloads (e.g., pictures of the flight) and communications (such as where the rocket currently is located). All this data can be sent to the cloud as well and to the manufacturer. In addition to Bluetooth, other longer-range communications can be utilized as well, such as Wi-Fi, cellular connections, etc.

The launch of the model rocket can be controlled through a mobile phone app (or simply web page running on a browser without a dedicated app) running on a mobile phone on any mobile operating system, including Android or iOS. An “arm command” would initiate the countdown although the countdown would discontinue if there is any sort of issue during the countdown. While the rocket is armed, the user can issue a “fire” command from the mobile phone which would launch the rocket. The fire command would require intentional activity from the user (such as holding a button down) for three (or more) seconds, thereby preventing an accidental launch.

The launcher would also include safety features that would avoid accidentally launching the rocket while connecting or disconnecting the controller to the launcher, and while connecting the launcher to the starter. There should be no single point failures that can make the starter hot. There can also be short circuit protection if the leads of the ignitor were too short. The users should be a predetermined distance from the launcher (e.g., 15 feet or greater) before the rocket would arm (and subsequently launch). The phone and/or launch pad hardware would continuously check the ignitor before and during the arming sequence. The launcher can use standard batteries (e.g., 6V/2A) or it can use a rechargeable battery (e.g., rechargeable with USB cable or wireless charging).

The launcher should be paired with only one controller (mobile phone) at a time. Security measures will also be in place to ensure that no other person (other than the person using the phone that is paired to the launcher) would have the ability to launch the rocket. When the launcher and controller (mobile phone running the app or browser) are paired, there should be a visual (and audible such as a beep) indication (on the phone and/or on the launcher itself such as an LED). When the controller and launcher is armed, there should be a further audible (e.g., a unique beep or other sound) and visual indicator (on the phone and/or also another LED on the launcher). During the countdown, there should be visible and audible countdown indicators on the controller (mobile phone) starting at five seconds (haptic feedback can be optional).

As such, the controller (app running on a mobile phone or web site on a browser on a mobile phone) should have an “arm” button and a “fire” button, in addition to a safety key. The safety key can be on the launcher itself and can require some type of physical key (or code/combination) in order to arm the rocket. Thus, the arm button would not work unless the safety key as been successfully operated (e.g., unlocked). Once armed, a “start countdown” button could be pressed that would start a beeping/flashing light countdown sequence for 5 or 10 seconds. If the rocket is not in armed status, pressing the start countdown button would have no effect. Once the countdown is complete, the “fire” button can then be pressed to actually launch the rocket. The fire button would have no effect unless the rocket is armed, the start countdown button was pressed, and the countdown has completed. The launch button (or any button on the phone) can be a “slide” button on the display in order to ensure the launch button is not accidentally pressed. Physical buttons on the phone (e.g., volume up/down, can be used as well in order to avoid accidental presses (e.g., pressing both volume up and volume down at the same time) to launch the rocket. So, for example, to arm the rocket a button on the phone can be pressed. To start the countdown, a slider button (where the user has to press with his/her finger and slide across the screen) in order to activate the “start countdown button.” And then in order to actually launch the rocket, both the physical volume up and volume down buttons have to be pressed at the same time to launch. For any of the required button presses (arm, start countdown, launch), any of these types of button presses can be required (e.g., standard GUI button, long press, slider, physical buttons).

To launch a model rocket, there is typically a launch process that ensures a safe launch. The launch process will perform numerous safety checks at different points in the process in order to make sure that before each system is activated, all prerequisite conditions are satisfied. If at any time, a prerequisite condition that was previously satisfied becomes unsatisfied, it would abort the launch process.

Note that before a user can utilize an app (or web site) dedicated to facilitating a launch, the user would have to register with a cloud server (typically administered by manufacturer of the model rockets). The user would provide his name, address, email, and all other such profile information. The cloud server would track the user's activity, such as his/her launches, purchases, inventory of engines, videos of launches, etc., so that this information can be utilized for marketing and other purposes at a later time.

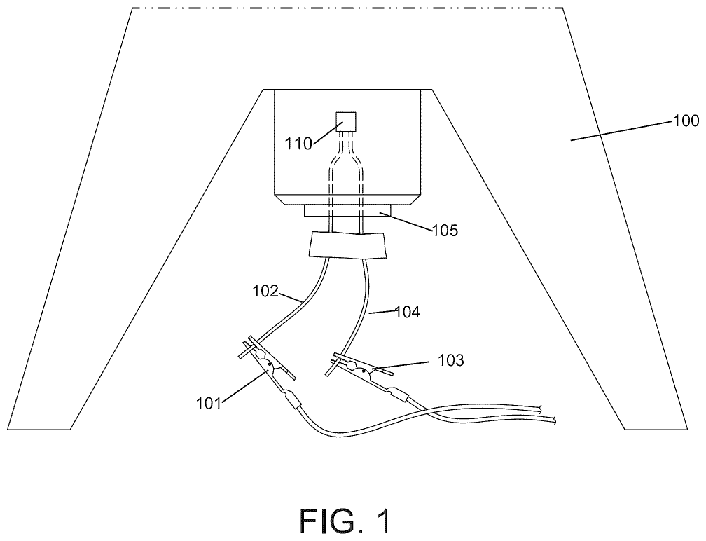

FIG. 1 is drawing illustrating a rocket engine with an igniter inserted therein, according to an embodiment.

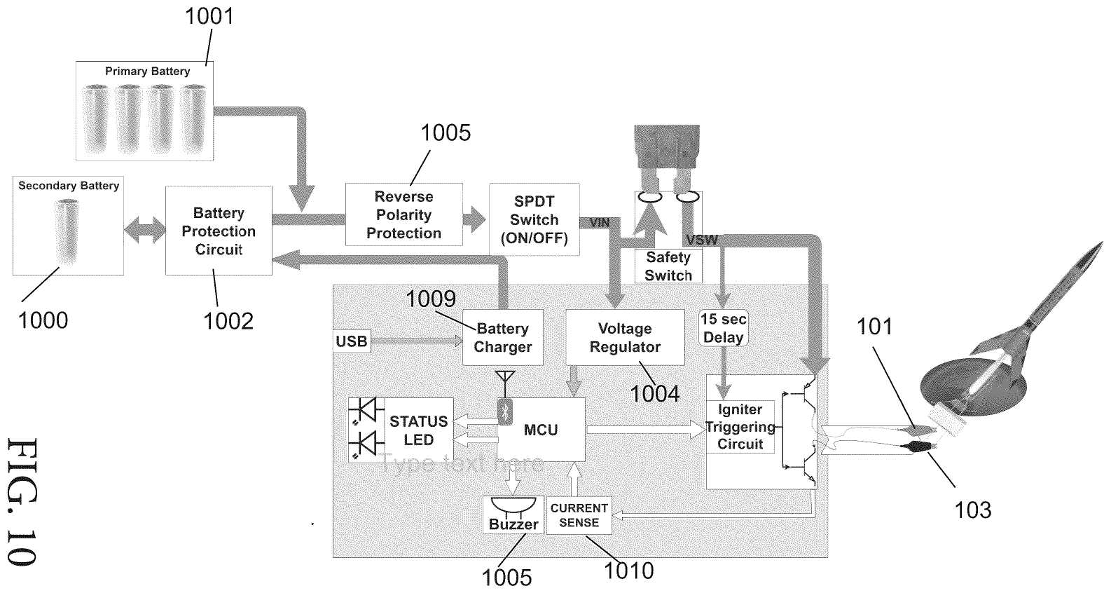

An igniter is inserted into a rocket engine 105 of a rocket 100. A first igniter wire 102 is connected to a positive terminal 101, and a second igniter wire 104 is connected to a negative terminal 103. Note that the polarity of the terminals typically do not matter. The positive terminal 101 and the negative terminal 103 lead into the launcher where they can be connected to a circuit which can selectively trigger current to the terminals 101, 103, thereby igniting the igniter. The negative terminal 103 can connect to a ground and the positive terminal 101 can connect to a pin on an processor which can selectively send current when instructed to, or alternatively, the positive terminal can connect to an output of a voltage booster of which is driven by a pin on the processor in order to generate enough current in order to ignite the igniter when energized. The terminals 101, 103 are connected to ignitor terminals 102, 104 (e.g., nichrome wire) which connect to an flammable substance 110 (e.g., a pyrogen which can be made, for example, from potassium nitrate, sulfur, and charcoal) 110. The pyrogen 110 is a flammable chemical which ignites when it receives current (e.g., 2.5 amps) which then ignites the rocket engine 105 causing the rocket to launch. Ignitors (comprising the ignitor terminals 102, 104 and the pyrogen 110) are available off the shelf. Model rocket engines are also available off the shelf and can, for example, be made from charcoal (carbon), sulfur, and potassium nitrate. The terminals 101, 103 can be connected to an ignitor triggering circuit (see FIG. 10) which can be connected to a microcontroller (see FIG. 10) so that the microcontroller of the launcher can initiate the launch by sending a suitable current (e.g., 2.5 amps) to the ignitor terminals thereby igniting the pyrogen. Before the pyrogen is ignited, typically current can flow through the ignitor terminals (through the pyrogen), but once the pyrogen is ignited, current can no longer for through the terminals as the pyrogen ignites and the connection is broken. Before ignition, the pyrogen-coated nichrome wire can conduct the electrical current needed to heat the wire and trigger the ignition, but after combustion, the material burns away or becomes non-conductive residue, ceasing to pass current.

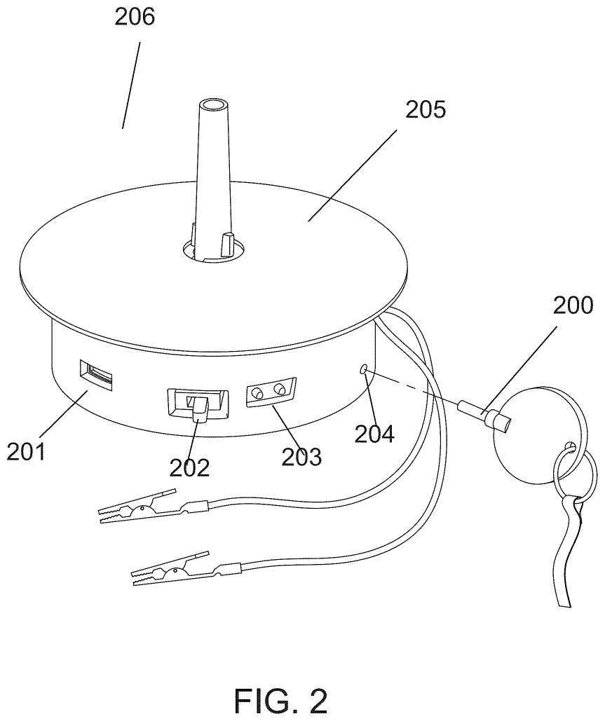

FIG. 2 is a drawing illustrating a launcher with a key not inserted, according to an embodiment.

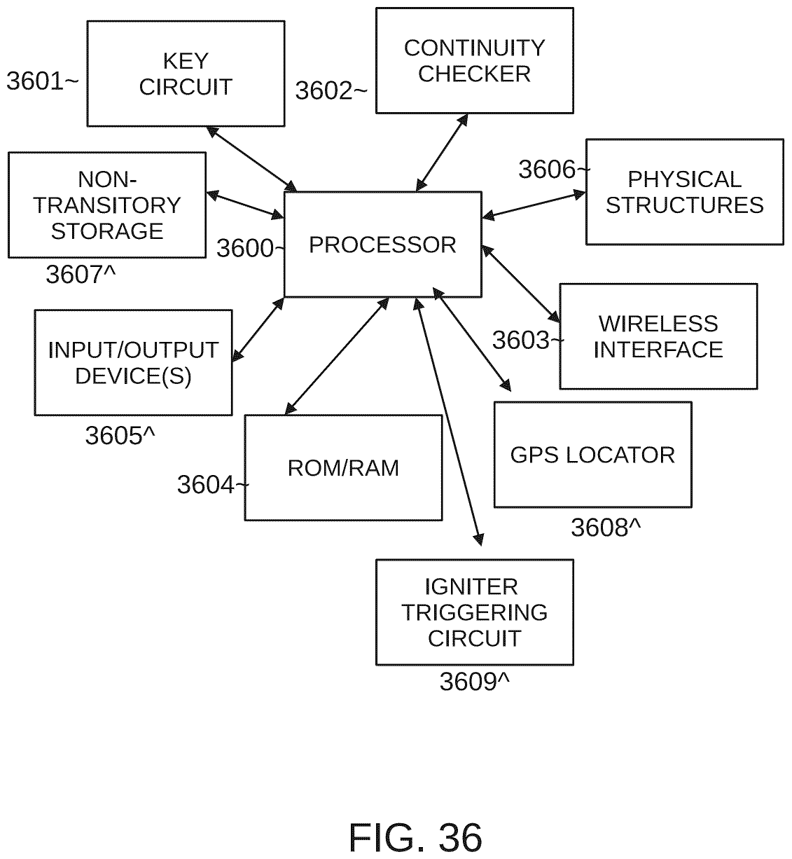

The launcher 206 comprises a launchpad 205 in which the rocket sits on top of. The launcher 206 also comprises a USB port 201 which is used to charge the electronics inside the launcher 206 (see FIG. 36). The launcher 206 also comprises an on/off switch 202 used to power on and off the launcher, and a set of LEDs 203 which can be used to indicate the status of the launcher (e.g., pairing status, armed status). The launcher 206 can also comprises a keyhole 204 to which a metal key 200 can be inserted therein. When the key 200 is inserted into the keyhole 204, the metal key 200 can complete a circuit and thereby the presence of the key 200 is detected by the circuit therein. The key 200 is required to be inserted into the launcher in order for the rocket to launch.

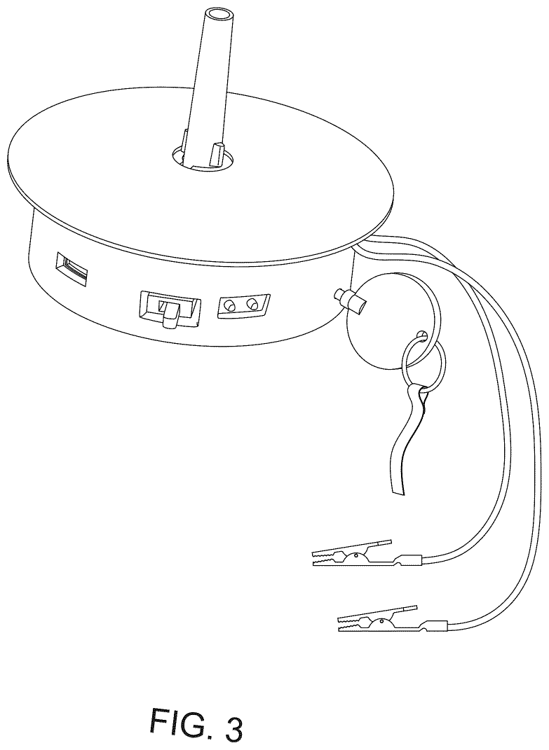

FIG. 3 is a drawing illustrated a launcher with the key inserted therein, according to an embodiment. Note that in FIG. 3, the key 200 is inserted into the keyhole 204, thereby completing the circuit therein and enabling the rocket to be launched.

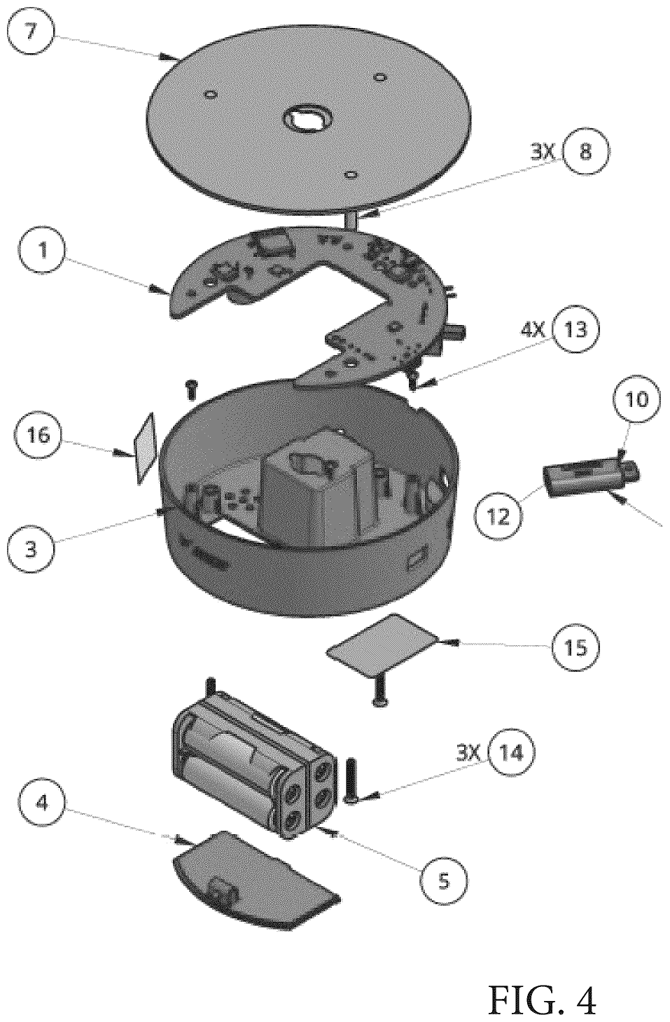

FIG. 4 is a drawing of a housing of a launcher, according to an embodiment.

A printed circuit board assembly 1 is attached below a blast deflector 7. Connectors 8 can be used to attach the blast deflector 7 to the enclosure 3. An enclosure 3 houses the printed circuit board assembly and is attached to the launch pad 7 via enclosure mounting screws 14. The printed circuit board assembly 1 is attached to the enclosure via PCBA mounting screws 13. A battery lid 4 snaps onto the battery pack 5. A label 15 can optionally also display a passcode that needs to be entered into the app to arm the launcher. A QR code 16 can also be displayed on the enclosure 3 which can be used to scan to pair the mobile phone to the processor 3600 of the launcher. An output interface 12 is connected to the processor 3600 on the printed circuit board assembly 1 and comprises LEDs 10 which are used to output the launch status (powered on, armed, countdown in progress, etc.) of the launcher.

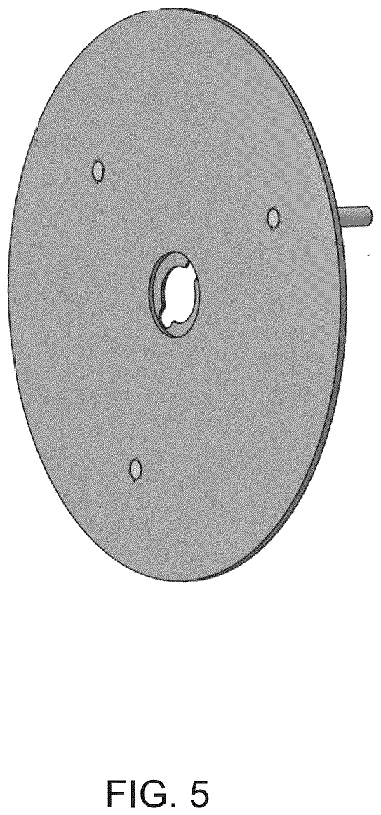

FIG. 5 is a drawing of a blast deflector of a launcher, according to embodiment.

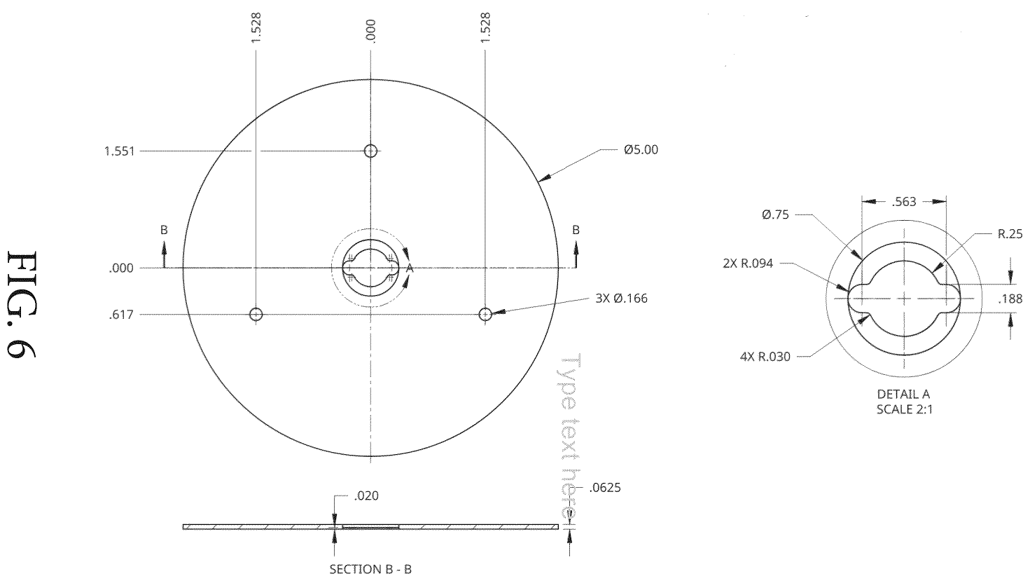

FIG. 6 is a further drawing of the blast deflector, according to an embodiment.

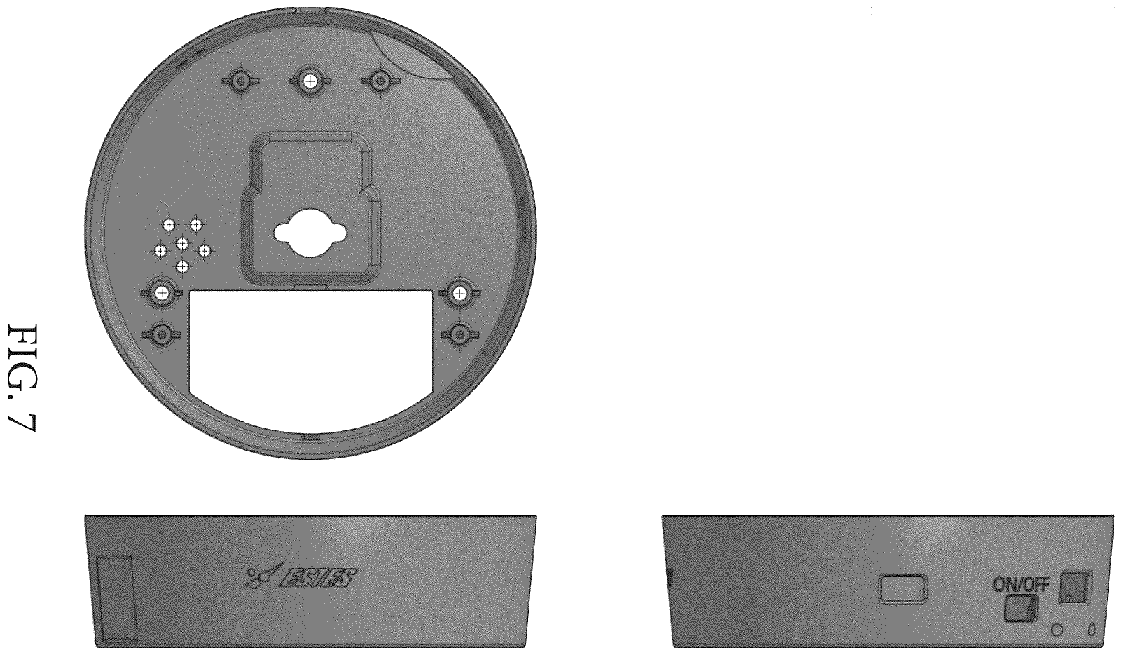

FIG. 7 is a drawing of an enclosure for a launcher, according to an embodiment.

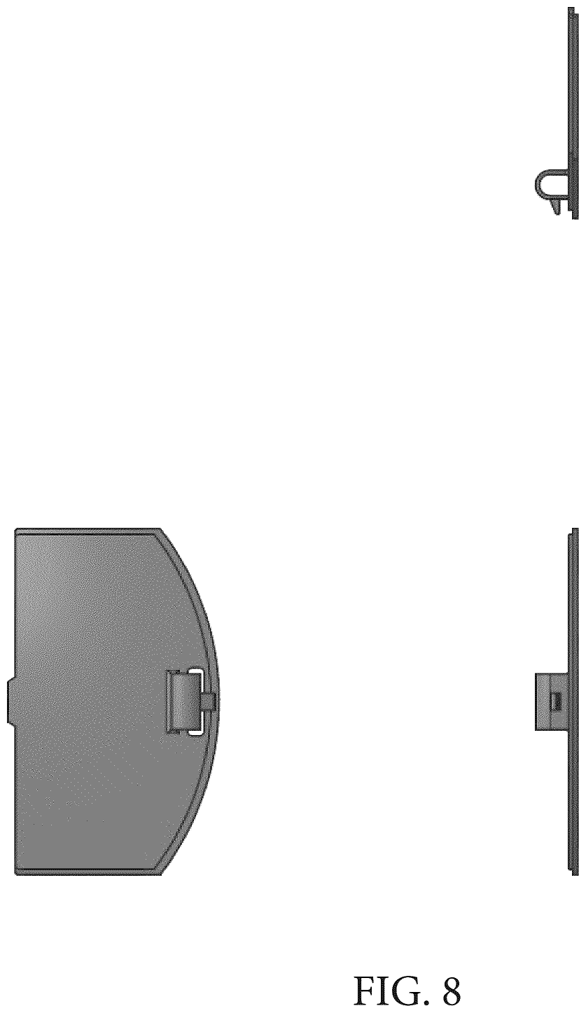

FIG. 8 is a drawing of a battery lid for a battery for the launcher, according to an embodiment.

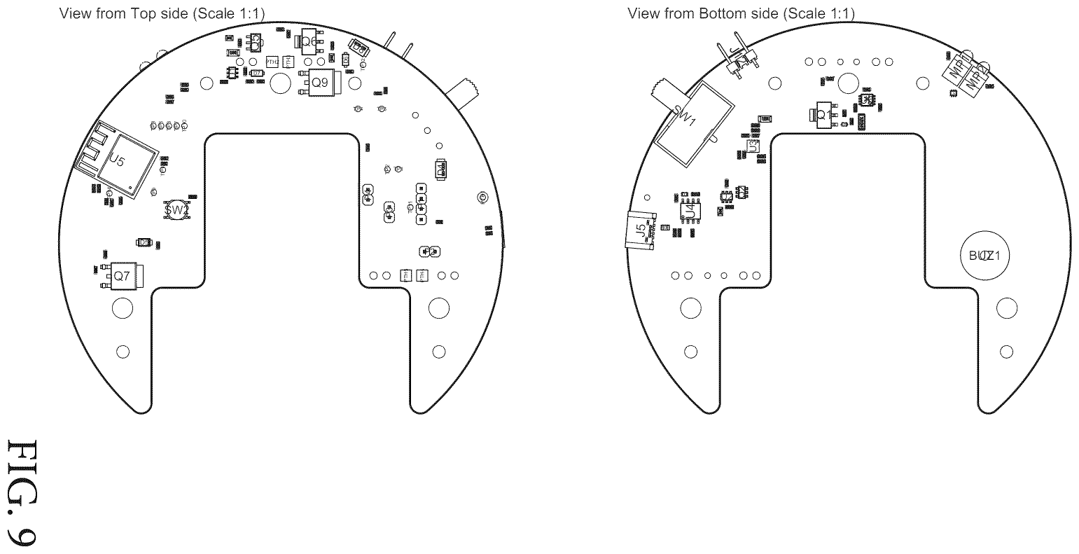

FIG. 9 is a drawing of a printed circuit board for the launcher, according to an embodiment.

FIG. 10 is a block diagram of the electronics for the launcher, according to an embodiment.

Note that a primary battery 1001 is used as well as a secondary battery 1000 which serves as a backup battery in case the primary battery 1000 loses its charge. A battery protection module 1002 is used to ensure that both batteries are not overcharged and are also not entirely depleted. A reverse polarity protection module 1005 is provided in order to automatically shut off if batteries are connected in the incorrect polarity so as to not damage the system. A MCU (microcontroller, also referred to as processor (see FIG. 36, 3600) is used to control the launcher and its communications with other devices (remote servers, the mobile phone running the app, etc.) A voltage regular 1004 is used to convert the voltage from the batteries to one suitable for the microcontroller. A buzzer 1005 is used to make an audible noise when the launcher is armed and the countdown has begun. Status LEDs 203 are used to indicate the status of the launcher. For example, an LED could light up when the launcher is in the armed mode (ready to launch). Another LED can light up with the launcher is in the pairing mode (waiting to receive a Bluetooth signal from the portable communications device (also referred to herein as cell phone, phone, or other similar terminology), so the two devices can pair with one another). An igniter triggering circuit 1007 is used to send a current to the igniter leads in order to ignite the igniter. The igniter triggering circuit can utilize one or more transistors in order to generate enough current to ignite the igniter (when energized by the processor). A current detector 1010 can be used to detect whether current is received from the igniter terminals which would be indicative of whether the igniter has burned out (in which there would be no current) or has not burned out (in which there would be current). If the igniter has burned out, it can be assumed that the rocket has launched. If there is no current in the first place (before launch), it can be assumed that the igniter was not properly placed and clipped between the igniter terminals. A battery charger module 1009 is used to recharge the batteries (which can be rechargeable).

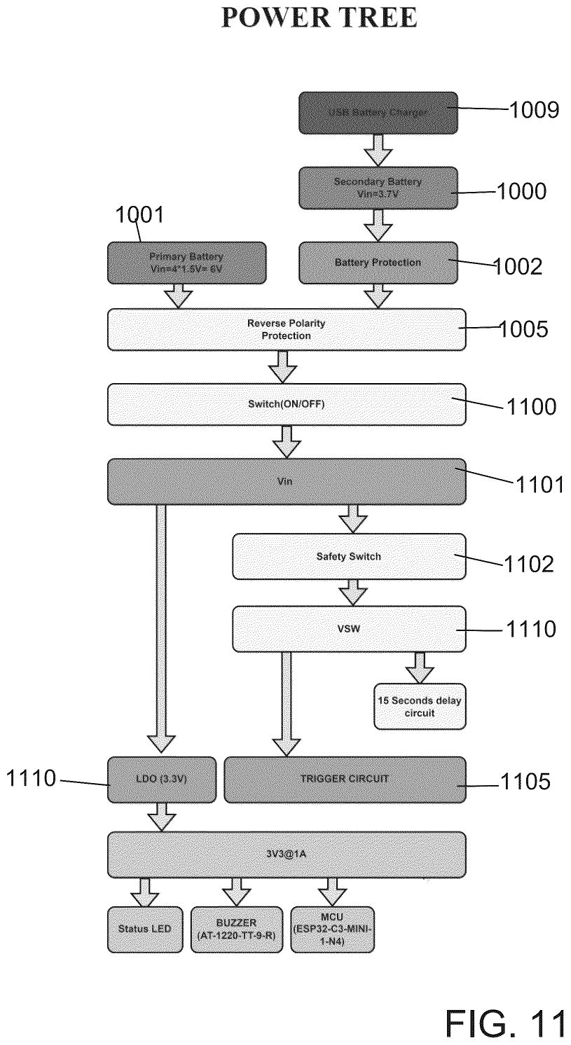

FIG. 11 is a block diagram illustrating power modules for the launcher, according to an embodiment. A USB battery charger 1009 is used to charge a secondary battery 1000 which is connected to a battery protection module 1002 to protect the secondary battery (and the primary battery) from overcharging. The primary battery 1001 and the secondary battery 1000 are connected to a reverse polarity protection module 1005 which can disconnect the power if the polarity is accidentally reversed in order to avoid damaging any of the circuits. A power switch 1100 is used to turn power off and on to the input VIN 1101 of the circuit. A safety switch 1102 can also be used to automatically turn the power off in case of an anomaly. A trigger circuit 1105 can be used to trigger the igniter to burn up, thereby launching the rocket. A voltage safety switch (VSW) 1110 can be used to cut the power off in the case of excess voltage. A low drop-out regulator (LDO) 1110 is connected to the voltage in 1101 which can provide a stable output voltage.

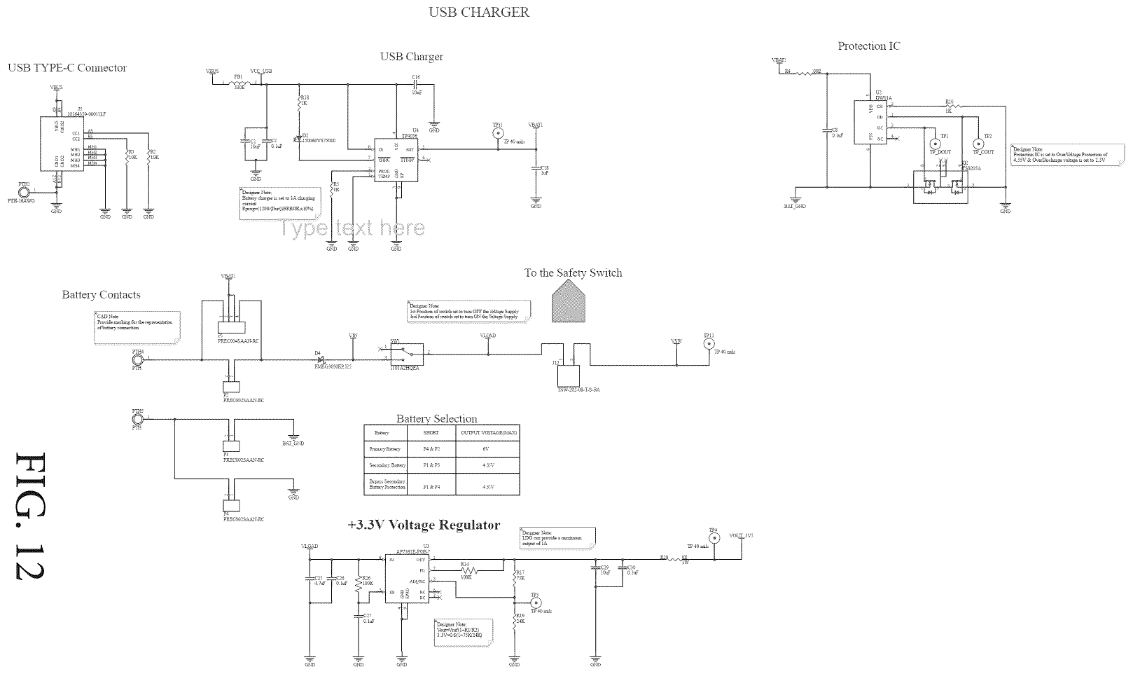

FIG. 12 are circuit diagrams for various aspects of the launcher, according to an embodiment.

Illustrated are the circuit diagrams for the USB charger, the battery contacts, the voltage regulator, and the protection IC. Of course, these configurations are merely examples, and other designs can be used as well which serve these functions.

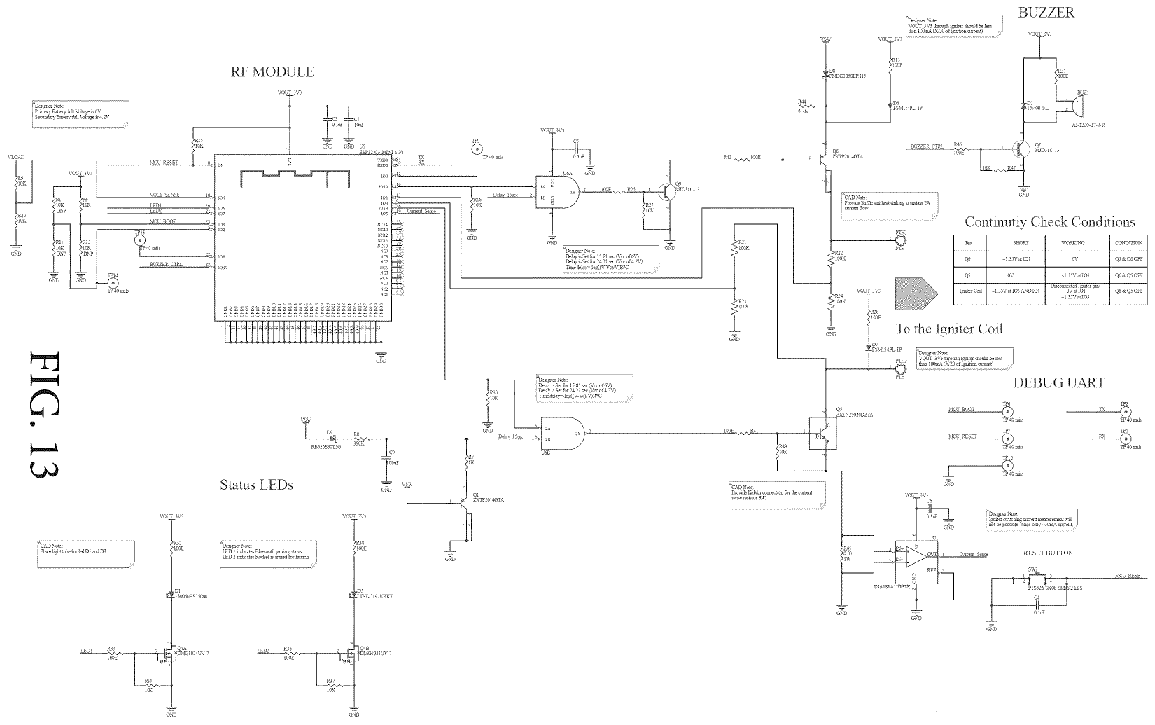

FIG. 13 are additional circuit diagrams for various aspects of the launcher, according to an embodiment.

Illustrated are the circuit diagrams for the RF module, continuity check circuit, status LEDs, buzzer.

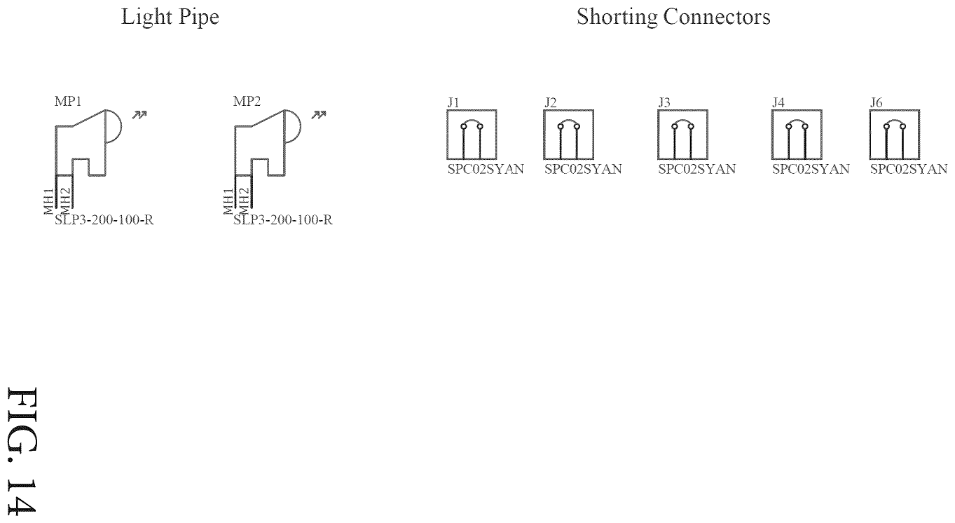

FIG. 14 is a drawing of light pipes and shorting connectors for the launcher, according to an embodiment.

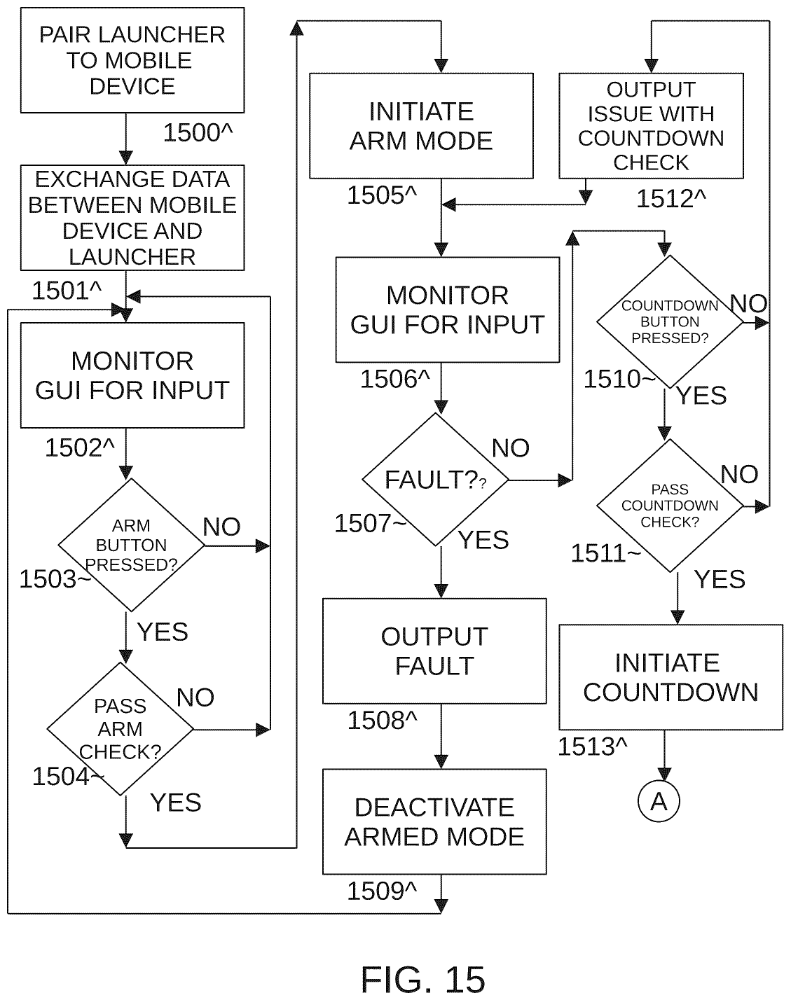

FIG. 15 is a flowchart illustrating a first sequence of an exemplary method of implementing launching a model rocket, according to an embodiment.

In operation 1500, a mobile device (such as a mobile phone, tablet, personal computer, etc.) would be paired to a launcher. The mobile device would have wireless communication capabilities, such as any combination of Bluetooth, BLE (Bluetooth Low Energy), Wi-Fi, NFC (near field communication), RFID (radio frequency identification), WiMAX, UWB (Ultra-Wideband), Cellular networks (e.g., 4G LTE, 5G, etc.), or any other wireless protocol that is not listed here.

In operation 1500, the mobile device would be paired to the launcher. The pairing can be performed using Bluetooth, but any other wireless protocol can be used as well. Pairing refers to enabling communication between the mobile device and the launcher so that they can exchange information (typically directly, although the transmissions therebetween can be indirect as well).

From operation 1500, the method proceeds to operation 1501, which exchanges data between the mobile device and the launcher. Any type of data can be exchanged between the two devices, such as statuses of components, commands, video signals, audio signals, etc. Note that operation 1501 can be performed continuously throughout the method and is not necessarily performed at one particular discrete time. Anytime that information needs to be transmitted from the mobile to the launcher or vice-versa, (or even from another participant in the system such as a cloud computer) the information would be transmitted as needed using the respective transmission technology (e.g. Bluetooth, WIFI, etc.) and the respective protocols for that transmission technology (e.g., UDP, HTTP, etc.).

Note that there can exist multiple launchers in the same area, and the mobile device would typically be only able to pair with one launcher at a time. Each launcher can have a unique identifier (either printed physically on the launcher, or a number used digitally in the code, or both). The mobile device would display the identifier of the launcher that the mobile device is currently paired with so that there is no misunderstanding of which launcher is being processed. Note that the same mobile device can utilize multiple launchers contemporaneously, however, the device would have to switch between each launcher for the user to operate on that respective launcher. Note all interactions, checks, etc., are performed for the launcher (and rocket on that launcher) associated with the pairing. So, for example, if the mobile device is paired with launcher “001” then all checks, buttons, etc., will operate only on launcher “001.” The user has the ability to switch the pairing to another rocket on launcher “002” upon which all interactions will then operate on launcher 002. The user is free to switch back and forth between an unlimited number of launchers on the same mobile device. Each launcher (and rocket therein) is processed independently of the others.

From operation 1501, the method proceeds to operation 1502, which monitors a Graphic User Interface (GUI) for input from a user. A GUI is displayed on the screen of the mobile device. The GUI can be running on a dedicated app, or it can be displayed on a browser which is visiting a web site which codes the GUI. The GUI would display particular buttons which control the launch process. In operation 1501, the processor of the mobile device is “watching” for button presses and upon a button press (or mouse click, etc.), an appropriate action will then be triggered.

From operation 1502, the method proceeds to operation 1503, which determines whether an “ARM” button is pressed. The arm button is utilized when the user wishes to arm the rocket for launch. When a rocket is placed in the launcher, arming it is the first step in order to launch it. The initial status will be “disarmed,” then the next status in the launch sequence would be “armed,” and then the next status in the launch sequence would be “countdown,” and then the final status in the launch sequence would be “launch.” At each step, the system would perform safety (and other) checks to make sure everything is OK before it proceeds in the launch sequence. If the “ARM” button is not pressed, then the method can return to operation 1502 which continues monitoring for input from the user. Note that the system is monitoring for any activity from the user, not just for the “ARM” button press.

The arm button can be a simple virtual button on the display device of the mobile device, but it can also be a more complex interactive element as well. For example, it can be a slider button which requires the user to slide the button along the display. It can be a long press button, which requires the user to hold the button for a predetermined period of time (e.g., five seconds). It can also require the user to press a physical button on the mobile device itself (e.g., volume up, volume down, or both simultaneously). The reasons for these special button presses would be to avoid any accidental arming of the rocket.

If in operation 1503, the ARM button was pressed, the method proceeds to operation 1504, which performs an arm check. The arm check will check numerous systems in order to ensure everything is safe before putting the rocket in armed status. The rocket cannot proceed in the launch process unless it is in armed status. In other words, if the rocket does not pass the arm check, then the rocket cannot be launched (the user will of course have the opportunity to rectify whatever situation is causing the failure of the arm check).

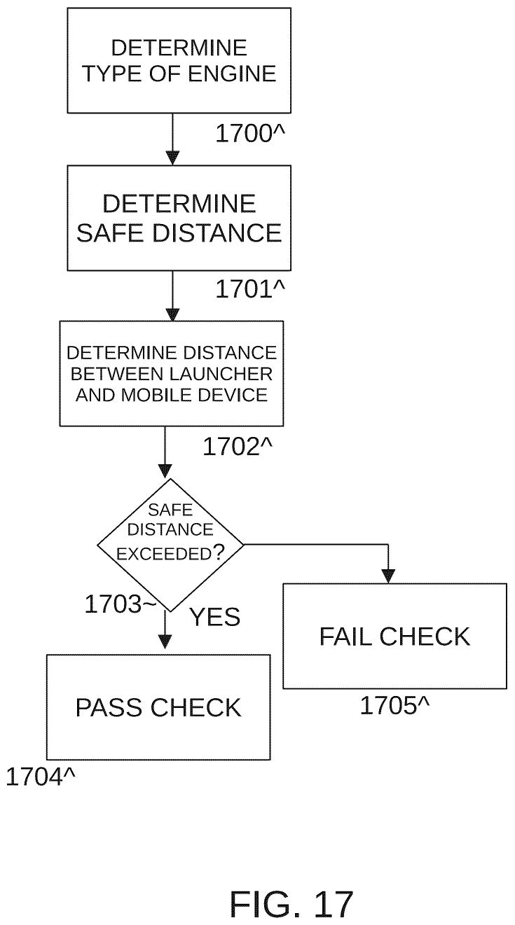

Various systems will be checked before the arm check is passed. For example, the proximity of the launcher to the user of the mobile device will be checked to make sure that there is at least a predetermined amount of distance between the user and the launcher (this can be done as illustrated in FIG. 17). In addition, the current in the launcher can be detected to confirm the current amount going between two clips that are attached to the engine is in the proper range. In addition, the temperature of the launcher can be checked to determine that the temperature of the launcher is in a proper predetermined range. A physical (or electronic) key can be used in order to unlock the rocket to help avoid accidental launches. As part of the arm check, the system would check that the key is (or has been) inserted into a lock (or another receptor for the key) to ensure that the key is present. The microcontroller on the launchpad can be queried to ensure that it is in the proper launch mode as well. In addition, a microcontroller that can optionally be present on the rocket can also be queried to ensure that it is in the proper launch mode. If any of these conditions are not satisfied, then the launcher will not be able to go into the arm mode and the method will return to operation 1502. A message would typically be displayed to the user explaining what the issue was that prevented the rocket from arming so that the user can correct the issue.

If in operation 1504, the arm check is passed, then the method proceeds to operation 1505, which initiates the arm mode. The arm mode can be stored as a register on the app and/or on the launcher itself. A visual indicator on the launcher and on the mobile device would indicate that the launcher is now in the “armed” mode. The launcher can have an LED indicating that would only illuminate when it is in the armed mode. An audible indicator can also be used to indicate the rocket is now armed, such as a beep, a voice saying “armed,” etc.

From operation 1505, the method can proceed to operation 1506, which continues to monitor the GUI for further inputs. Now that the launcher is armed, the next step would be for the user to initiate the countdown. Note that the countdown can be optional, and, in an embodiment, the user can go directly from the armed status to launching the rocket.

While the mobile device is monitoring the GUI for input, the method can proceed to operation 1507 which is checking for a fault. A fault is a required condition that was satisfied during the arm check in operation 1504 that is no longer satisfied. For example, the temperate had to be checked and be determined to be in an acceptable range in order for the arm check to be passed, but now the mobile device would check this temperature again to ensure that it is still in the acceptable range. If it is not, then it is considered a “fault” and the method would proceed to operation 1508, which would output to the user in the display device the type of fault (e.g., what went wrong) so that the user can address that issue. From operation 1508, the armed mode would be deactivated to avoid launching a rocket with a fault and the method would return to operation 1502 where the user can try to remedy the fault and go back to arming the rocket.

In operation 1507, all conditions that were checked in order to pass the arm check (in operation 1504) can be checked again to confirm all such conditions are still satisfied. This fault check can continuously operate in operation 1507 so that a failure of one system could not result in a launch (until that failure is rectified).

If in operation 1507, a fault is not detected, then the method proceeds to operation 1510, which determines whether a countdown button is pressed. A countdown button can be any type of interactive element on the GUI, preferable one that is not a simple button press in order to avoid an accidental activation of the countdown. For example, a slider, long press, physical mobile device buttons, simultaneous press of physical mobile device buttons, etc., can all be used as the countdown button. If the countdown button has not been pressed, then the method can return to operation 1506 which continues to monitor the GUI for input from the user.

If in operation 1510, the countdown button was pressed, then the method proceeds to operation 1511, which implements a countdown check. A countdown check is similar to the arm check (in operation 1504) and would check for all of those conditions but can include even more conditions that were not in the arm check. For example, a check of the current weather can now be performed (either by remote weather service or by a moisture detector to determine if it is raining) to ensure that the rocket would not launch if it is raining (in other words, the countdown check confirms it is not raining before passing the countdown check).

If in operation 1511, the countdown check is not passed, then the method proceeds to operation 1512 which outputs to the user what went wrong with the countdown check and why it was not passed. The method then returns to operation 1506 which continues to monitor the GUI for input. The user can then try to address whatever issue prevented the countdown check from passing and then press the countdown button again. In one embodiment, even though the countdown check was not passed, the launcher would remain in the “armed” state. However, in another embodiment, if the countdown check was not passed, then method would return to operation 1502 and the “armed” status would be reset so that the launcher would not be armed any longer and the user would have to go through the arming process again.

If in operation 1511, the countdown check was passed, then the method proceeds to operation 1513, which initiates the countdown. The countdown would display on the mobile device a countdown (e.g., from 5 down to 0) and can also speak the numbers audibly as well. In addition, another LED on the launcher would light up to indicate the countdown has been initiated, and sounds on the launcher would be triggered as well (e.g., a buzzer, beeping, etc.)

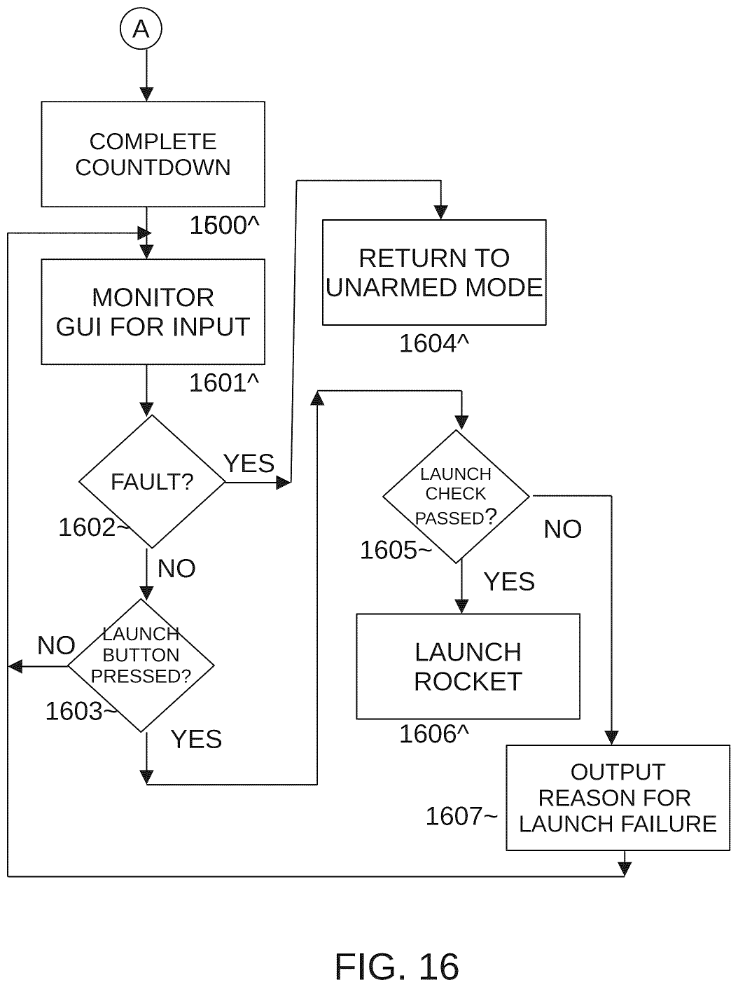

From operation 1513, the method proceeds to FIG. 16, operation 1600, which completes the countdown. The countdown ends with “zero,” but the rocket would not launch until the user presses a “launch” button. From operation 1600, the method proceeds to operation 1601, which monitors the GUI for input including if the launch button (or buttons) is being pressed. From operation 1601, the method proceeds to operation 1602, which determines if there is a fault. All of the conditions for the arm check (operation 1504) and the countdown check (1511) are checked again to make sure all these conditions are satisfied in order to proceed with the launch. If in operation 1602, there is a fault (one or more of these conditions are not satisfied), then the method proceeds to operation 1604 which puts the launcher in unarmed mode and the returns to operation 1502. The mobile device would typically output to the user what condition was not satisfied so that the user can remedy that condition and try again.

If in operation 1602, if there is no fault, then the method proceeds to operation 1603, which determines whether the launch button is pressed. As with the arm button and the countdown button, the launch button can be a button, slider, long press button, physical buttons on the mobile device, combination of physical buttons on the mobile device, etc. If the launch button is not pressed, then the method returns to operation 1601 which continues to monitor for input from the user (including checking for a launch button press).

If in operation 1603, the launch button is pressed, then the method proceeds to operation 1605 which performs a launch check. The launch check would check for all of the previously checked conditions (including all checks in the arm check and the countdown check) and possibly some additional condition(s) that were not previously checked. If the launch check is not passed, then the method proceeds to operation 1607, which outputs on the display device a reason for the launch failure and returns to operation 1601, which continues to monitor the GUI for input. The user can attempt to remedy whatever the reason for the lunch failure is so that the user can try again to launch the rocket.

If in operation 1605, the launch check is passed, then the method proceeds to operation 1606, which launches the rocket. This can be accomplished by sending a wireless signal to an activator on the launcher itself which would pass a current through the clips which would ignite the rocket engine thereby causing liftoff. If there are any additional electronics on the launcher and/or the rocket itself (e.g., video camera, tracking devices, etc.) they would also be commanded to initiate as well. For example, a video camera on the launcher can be commanded to begin recording video (which can be transmitted to the cloud server). A tracking device on the rocket itself (e.g., GPS device) can be commanded to begin tracking the location of the rocket and transmitting signals wirelessly so that the rocket can be tracked.

One of the checks comprising the arm check is to make sure that the user is at least a sufficient distance from the launcher. This can be done by determining the required minimum distance based upon the rocket engine being used and then determining the actual distance using GPS locations of the launcher and the mobile device.

FIG. 17 is a flowchart illustrating a method to determine whether a launchpad is in safe proximity from a user, according to an embodiment.

In operation 1700, the type of engine used for the rocket loaded in the launcher is determined. This can be done in numerous ways. In one embodiment, the user would specify in the app (or browser) the type of engine being used. Alternatively, the user could specify the model of rocket being launched and the system could query a database to determine what type of engine that particular rocket uses. In another embodiment, a camera located on the launcher can automatically recognize the model of rocket being used and the engine can then be determined from the rocket model. In a further embodiment, engines can be coded with an RFID or QR code which would encode the type of engine.

From operation 1700, the method proceeds to operation 1701, which determines a safe distance from the launcher. This can be done by consulting a table, for example each rocket engine would have its own required minimum distance (e.g., at least 15 feet with D engines or smaller), and at least 30 feet when launching larger engines.

From operation 1701, the method proceeds to operation 1702, which determines the distance between the launcher and the mobile device. This can be done in numerous ways. For example, the location of the mobile device can be determined by using a GPS location (the mobile device would have its own GPS hardware or can determine its GPS position using other methods such as cell tower triangulation, etc.). The location of the launcher can be determined using GPS hardware on the launcher (or rocket itself) or a cellular device which can also use other methods such as cell tower triangulation, etc. The distance between the launcher and the mobile device can then be determined by subtracting the two GPS coordinates (or any other method).

Another method that the distance between the launcher and the mobile device can be determined is by the user taking a picture of the launcher/rocket from the same mobile device that is running the app/browser (or at least scanning the launcher/rocket from its camera app). From the image, the mobile device can determine (by the size of the launcher and/or rocket) how far away the launcher/rocket is. For example, the mobile device would have data about the size of the launcher (if launchers came in different models, it would know which particular model launcher is being used and the dimensions of that launcher). From the known sizes, the distance can then be determined using the simple formular: Distance=(S*f)/s, wherein S=the size of the launcher (or the rocket if the rocket is being used), s is the size of the launcher inside the image, and f is the focal length of the camera.

From operation 1702, the method proceeds to operation 1703, which determines whether the distance between the mobile device and the launcher/rocker (determined in operation 1702) is greater than (or greater than equal to) the safe distance (from operation 1701). If the safe distance is exceeded (or at least matched), then the method proceeds to operation, which 1704 and passes this particular check.

If the safe distance is not exceeded (or at least matched), or in other words, if the distance between the mobile device and the launcher is less than the safe distance, then the check for this condition fails. The user can be notified that they need to move further away from the launcher and try again.

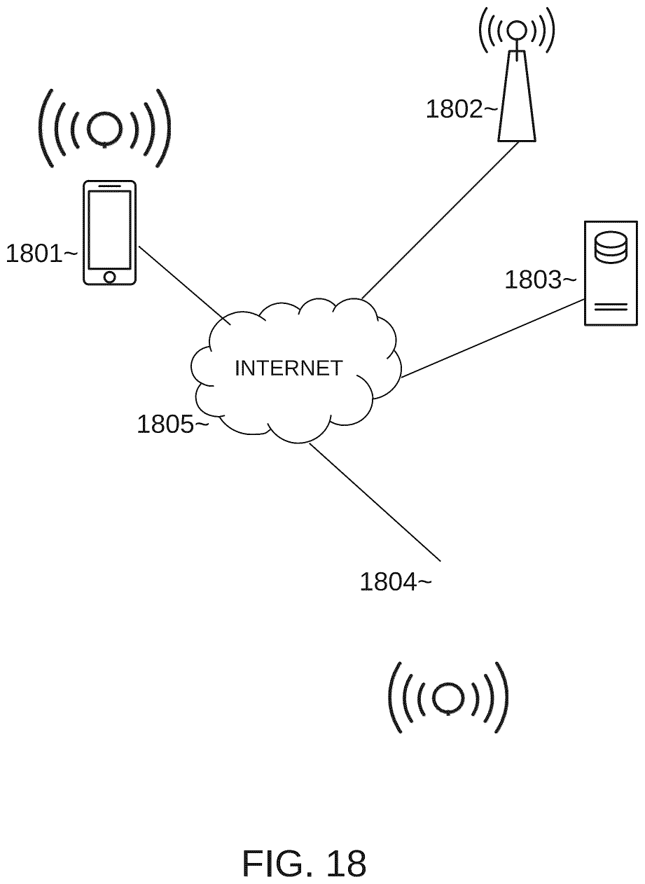

FIG. 18 is a block diagram illustrating a computer communications network, according to an embodiment.

A portable communications device (e.g., cell phone, tablet, laptop computer, etc.) 1801 is connected to the internet 1805 (or any other computer communications network) via cellular data or any other wireless protocol. The portable device 1801 can, for example, be configured as illustrated and described with regard to FIG. 18. A cloud server 1803 is also connected to the internet 1805 (or any other computer communications network) and can store all assets of programs needed to implement any aspect of the system, including customer records, back-office systems, app downloads, database systems, etc. While only a single cloud server 1803 is pictured, it can be appreciated that multiple servers can be operating in the same or different physical locations to handle computing processes as requested. A cell phone tower 1802 is utilized by any component illustrated in FIG. 18 (or not illustrated but mentioned herein) to communicate with the internet 1805 (or any other computer communications network). A model rocket and launcher 1804 is also equipped with wireless communications (e.g., WIFI, Bluetooth, etc.) and can communicate with any component illustrated in FIG. 18 (or not illustrated but mentioned herein). Note that the launcher can comprise a digital computer device which could include a microcontroller (MCU) such as an ESP32 or similar, RAM, ROM, nonvolatile storage, a networking unit(s) which can implement protocols such as Bluetooth, WIFI, input/output ports (such as input/output pins, serial interfaces, USB ports, etc.) The launcher can have its own code that can communicate with the app (or browser) running on the portable device to coordinate the launching operations.

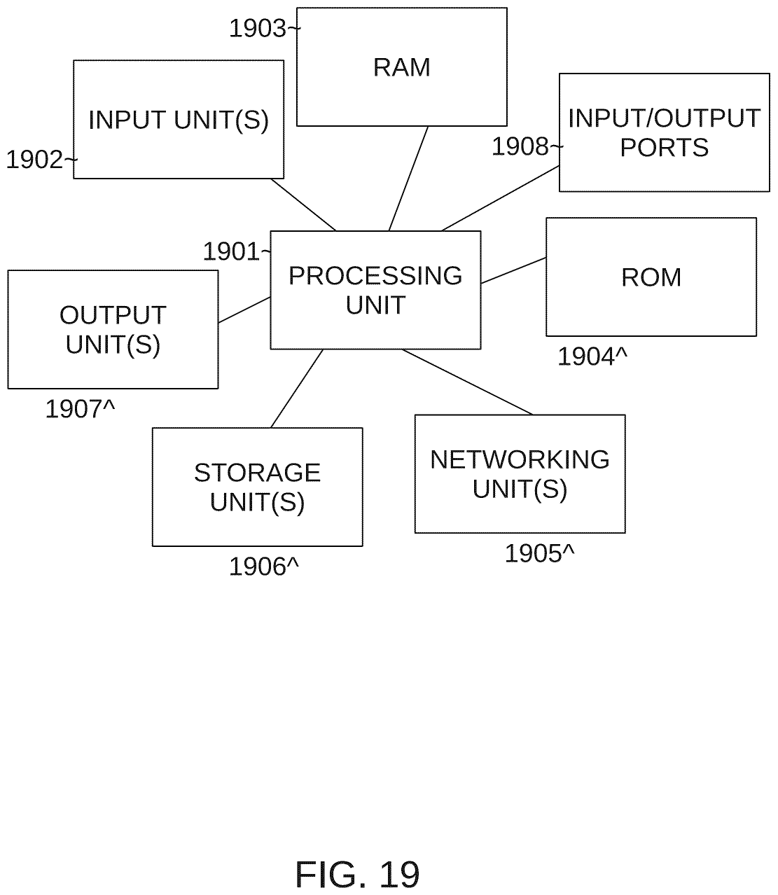

FIG. 19 is a block diagram illustrating computing hardware to implement a portable device or computer server, according to an embodiment. The portable device or computer server can be, for example, a cell phone, tablet, laptop computer, web server, database server, general computing platform, cloud server, file server, etc., and can have this general structure (of course it does not have to match exactly as in FIG. 19 and can have additional and/or alternate components than what is shown). A processing unit 1901 (such as a microprocessor) and associated structure (e.g., bus, cache, power supply, etc.) is connected (directly or indirectly) to various other components. The processing unit 1901 can be connected to an input unit(s) 1902, such as a touch screen, buttons, keyboard, etc., and an output unit(s) such as a display, speakers, etc. The processing unit 1901 can also be connected to a networking unit(s) 1905 which can implement any kind of networking protocol, including wireless protocols, such as Bluetooth, WIFI, or any other such protocols. The processing unit 1901 can also be connected to a ROM (which can contain instructions to implement methods described herein and including an operating system) and RAM. The processing unit 1901 can also be connected to input/output ports 1908 such as a USB port, serial interface, etc. Any other known hardware component can be part of the system, which can include, for example, a power management unit, real time clock, sensors, etc. The processing unit 1901 can also be connected to a storage unit(s) 1906 which can read and write to a respective non-transitory storage medium such as a flash memory, EEPROM, solid state drive, hard drive, etc. The non-transitory storage medium can store a computer readable program that, when executed by the processing unit 1901, causes the processing unit 1901 (and associated hardware) to implement any and all of the methods and features described herein. While a single processing unit 1901 is illustrated, it can be appreciated that multiple processing units can also be operating simultaneously and working together to execute computer readable instructions, whether in the same physical location or not.

In a further embodiment, an NFC (near field communication) key can be used to unlock a rocket. A physical key (dongle) would be embedded with an NFC tag. The portable device would have to have NFC reading capabilities. If the physical key is verified on the portable device, then the portable device would remotely unlock the rocket from the launcher so the launch process can continue. Note that a rocket would have a “locked” status, which would either be “locked” or “unlocked.” When a new launcher is initialized (e.g., paired with the portable device), the status would automatically become locked.

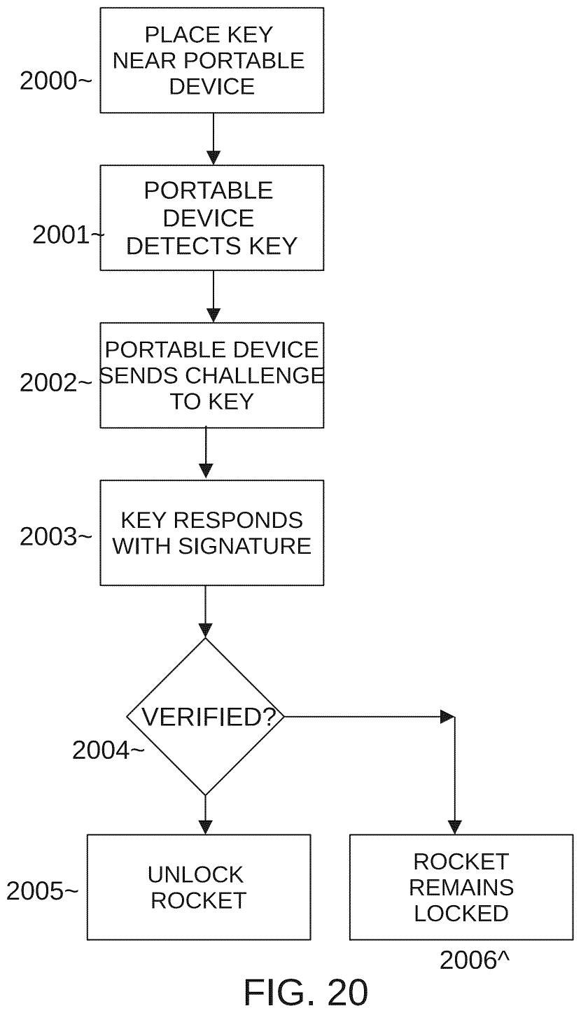

FIG. 20 is a flowchart illustrating an exemplary method of utilizing a physical hardware key to unlock a rocket, according to an embodiment.

In operation 2000, the user places the physical key near the portable device.

From operation 2000, the method would proceed to operation 2001, wherein the portable device would detect the presence of the key. The portable device would emit a radio frequency field to power and communicate with the key's NFC tag and then detect the presence of the key.

From operation 2001, the method proceeds to operation 2002, wherein the portable device transmits a challenge to the key wirelessly. The challenge can be a random number, time, nonce, etc.

From operation 2002, the method proceeds to operation 2003, wherein the key wirelessly responds to the challenge with a digital signature using the manufacturer's private key only known to the manufacturer but not known to the portable device.

From operation 2003, the method proceeds to operation 2004, in which the portable device uses the public key on the digital signature received in operation 2003 and verifies that the challenge was indeed encrypted properly using the private key. If this verifies, then the method proceeds to operation 2005. If this is not verified, then the method proceeds to operation 2006.

In operation 2005, the key is verified and so the rocket is unlocked. The portable device can transmit a code to the launcher indicating that the key has been presented and the rocket can unlock. In addition, the functionality of the app (or web site running on the browser) would allow the launch process to continue now that the rocket has been unlocked.

In operation 2006, the rocket would remain locked. This means that the app (or web site running on the browser) on the portable device would not allow the launch process to continue. The launcher also stores the status of whether the rocket is locked or unlocked, and the status would remain as locked, preventing the launcher from launching the rocket (even if the launcher were to receive a proper “launch” signal from the portable device).

In this manner, the rocket cannot be launched without both the physical presence of the kay as well as the associated smartphone running the app.

In a further embodiment, a cloud server can maintain detailed records about each user of the system and their launch history, purchases, etc. Purchases of supplies (rockets, engines, etc.) from the manufacturer can be made on the manufacturer's web site (using the app or on a web site running on a browser). Every purchase would require a user to be logged in to their account, thus every purchase a user makes would be tracked and stored in the user's account. As such, the cloud server would know which models of rockets each user has, how many engines they have purchased, how many they have utilized, etc. This data can be leveraged for numerous reasons, for example to selectively market additional supplied to users who may need them at the time.

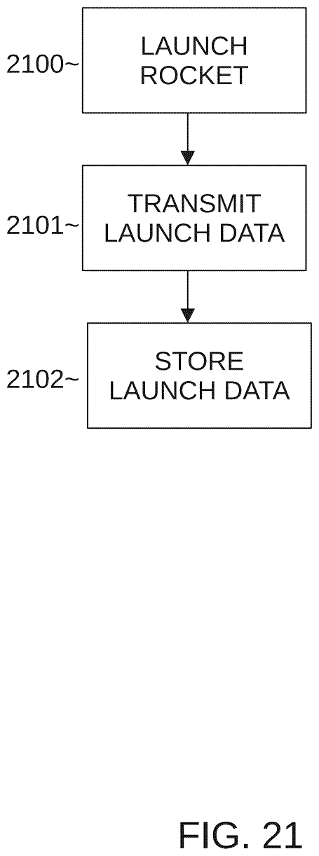

FIG. 21 is a flowchart illustrating an exemplary method to store launch data in a cloud-server, according to an embodiment.

In operation 2100, the rocket is launched. This can be done as described herein. The user would have to be logged into the app (or the web site being displayed on the browser), so the user's identity is known to the system.

From operation 2100, the method proceeds to operation 2102, which transmits launch data to the cloud server, which gets stored in a relationship database system (e.g., SQL database or other) so the user's launch history can be preserved. The launch data can include the date and time of launch, the model rocket launched, the engine used, the trajectory of the rocket after launch, the location it landed, any video and/or audio files of the launch, and all other data that the system may know about relating to the utilizing of the system. The launch data can be transmitted from the app (or browser) running on the portable device 1801 to the cloud server 1803. Alternatively, the launch data can be transmitted from the launcher 1804 to the cloud server 1803.

In this way, the cloud server 1803 would have a detailed history of all the user's activities with regard to utilizing the app, web site, and launcher. The cloud server 1803 would also store all orders made on the manufacturer's web site as well.

Since the cloud server has a detailed history of all activities of all the user's registered on the system (and typically all users will be required to register in order to utilize the system), this information can be utilized to improve the user's experience. Supplies can be suggested to the user when it is determined that the user is low (or out) of certain supplies (such as engines) and could use some additional ones.

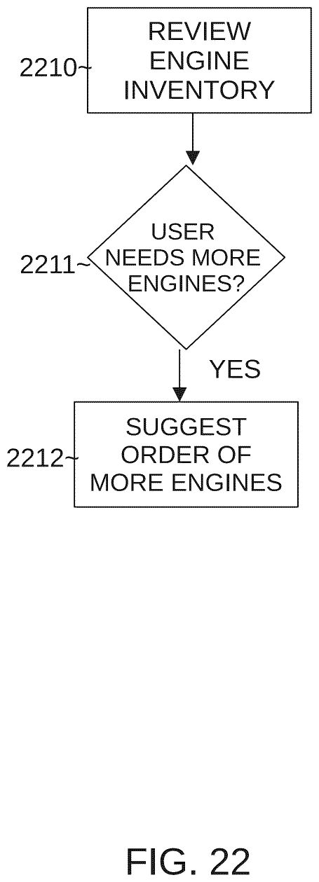

FIG. 22 is a flowchart illustrating an exemplary method to automatically suggest to a user to purchase engines when the is low on supply, according to an embodiment.

In operation 2210, the system would review the user's engine inventory. That is, how many engines of each size that the user has purchased, and how many engines of each size that the user launched. Subtracting the launched engines from the purchases engines would, in theory, provide the system with the exact number of each type of engine the user has on hand. For example, if the user purchased 10 D12-7 engines and 5 C6 engines, and launched 9 rockets utilizing a D12-7 engine and launched 2 rockets utilizing a C6 6engine, then the user should have 1 D12-7 engine and 3 C6 engines left.

From operation 2210, the method proceeds to operation 2211, which determines whether the user needs more engines. This can be done by comparing the computed inventory of each engine type to a predetermined minimum quantity (e.g., 2), and if the number of each engine type on hand is less than the predetermined minimum quantity than the system can suggest to the user to purchase more of that engine type. The system would also check to see if the user has model rockets that utilize that engine type before making the suggestion. For example, if the user has 0 B6-4 engines on hand, but has no model rockets that utilize a B6-4 engine, then the system would not suggest purchasing additional B6-4 engines because the user would have no use for them. Alternatively, if the system determines that the user has an excess of a particular type of engine (e.g., more than 10 engines of a certain type on hand), then the system can suggest to the user that he/she purchase particular models of rockets that utilize the type of engine that the user has extra inventory on hand. For example, if the user has 12 C11-5 engines on hand, then the system can automatically suggest (recommend) that the user purchase a “Mega-Lunar Rocket” which uses a C11-5 engine.

Once it has determined that the user could use more supplies (either rockets, engines, or both), then the method can proceed to operation 2212, which can suggest the user order more of the determined products. For example, an email can be emailed to the user with a link that when the user clicks it, the user would be presented with a shopping cart which already has the recommended (suggested) products already present. The user would simply have to click “OK” or some other type of button in order to automatically order these supplies.

The cloud server can also partner with other online markets (e.g., AMAZON) so that the suggested products can be suggested to the user while the user is visiting the AMAZON web site. The suggestion can be in a window which says, “click here to purchase this product” and the suggested products can be pictured in such windows, enabling the user to easily purchase these suggested products.

In a further embodiment, launches and other activity on the app (and web site) by the user can automatically be curated and published to a social network. For example, after a user launches a record, if video of that launch is available, a pop-up can be presented on a social network (e.g., FACEBOOK) where the user can automatically publish that video to the user's feed by simply pressing a button.

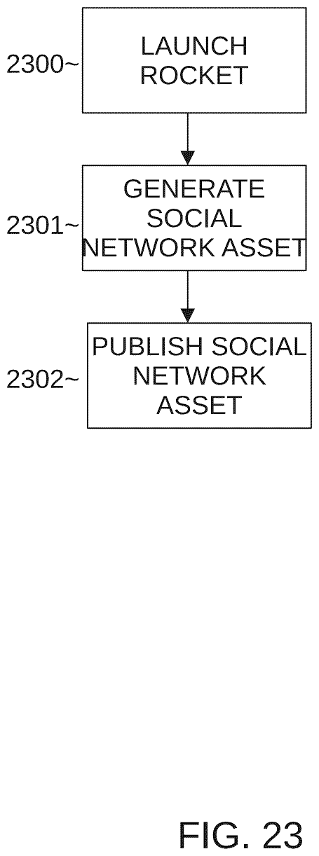

FIG. 23 is a flowchart illustrating an exemplary method of publishing assets related to launches to a user's social network, according to an embodiment.

In operation 2300, the user would launch a rocket. This can be done as described herein.

From operation 2300, the method proceeds to operation 2301, which generates a social network asset. For example, a video of the launch can be augmented with text describing the launch, such as “Big Bertha rocket launched on Aug. 1, 2024, at 9:45 am” or something like that. The user can simply press (click) a button in order to publish that asset to the user's social network account if the user wishes to. If the rocket itself has a camera, that camera video could also be transmitted to the cloud server via a cellular network. That video feed can be augmented with text that reads “See Miami from a rocket's perspective” as it would know which city was filmed by the GPS data from the rocket (or launcher or portable device). The system can automatically combine multiple video feeds into one video. For example if the rocket itself has a camera (typically facing the ground) and the launcher also has a camera (typically facing the rocket) then a video can be automatically generated combing both feeds (the rocket launching simultaneously with the video of the ground taken by the rocket) so the view can watch both videos simultaneously and in sync (both being presented with the same amount of elapsed time after launch).

From operation 2301, the method proceeds to operation 2302, in which once the user agrees to publish the social network asset and clicks a button to publish it, the social network asset will be published (e.g., to FACEBOOK, LINKEDIN, etc.) and would be made available to the user's connections in accordance with the protocols of that particular social networking site.

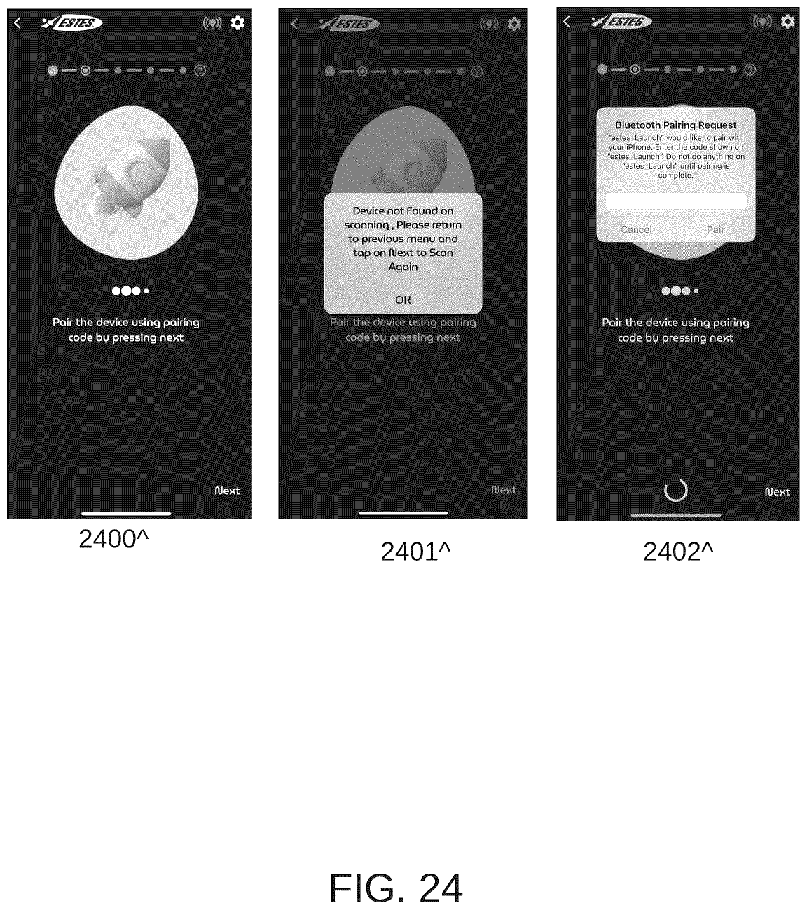

FIG. 24 is a set of screen shots showing example pairing messages, according to an embodiment.

First pairing screen 2400 can be displayed in order to prompt the user to pair his/her launcher with the user's cell phone (cell phone is also referred to herein as mobile phone or portable device). Second paring screen 2401 can be displayed when the user's cell phone does not find the launcher after searching for Bluetooth devices nearby. If the cell phone's Bluetooth interface finds the launcher's Bluetooth beacon, then third pairing screen 2402 can be displayed which prompts the user to enter a code. The code can be affixed to the launcher (e.g., a sticker) or provided to the user in any other manner. If the code matches the predetermined code, then the cell phone will successfully complete the pairing process. If the code does not match the predetermined code, then the cell phone will not be paired with the launcher (and the launch process cannot continue).

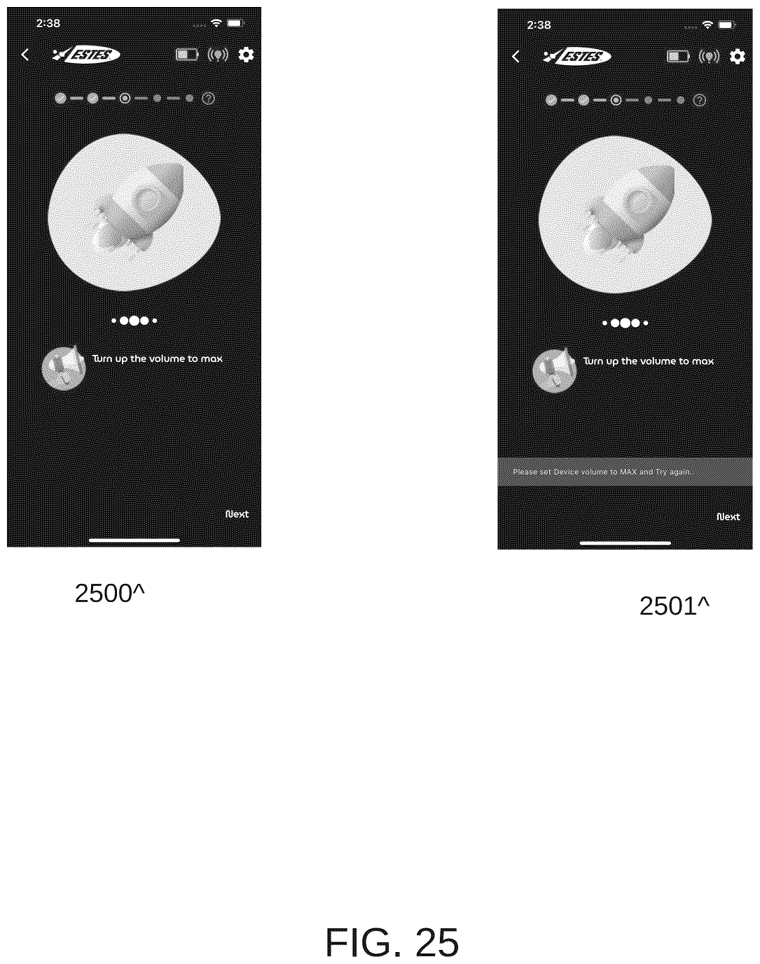

FIG. 25 is a set of screen shots showing example volume control messages, according to an embodiment.

First volume control prompt 2500 prompts the user to turn up the volume to the max (highest) possible volume the cell phone has. If the user has not turned up the volume to the highest possible volume, and the app cannot set the volume to the highest possible volume on its own, then second volume control prompt 2501 informs the user to put the volume up to the highest possible volume and try again.

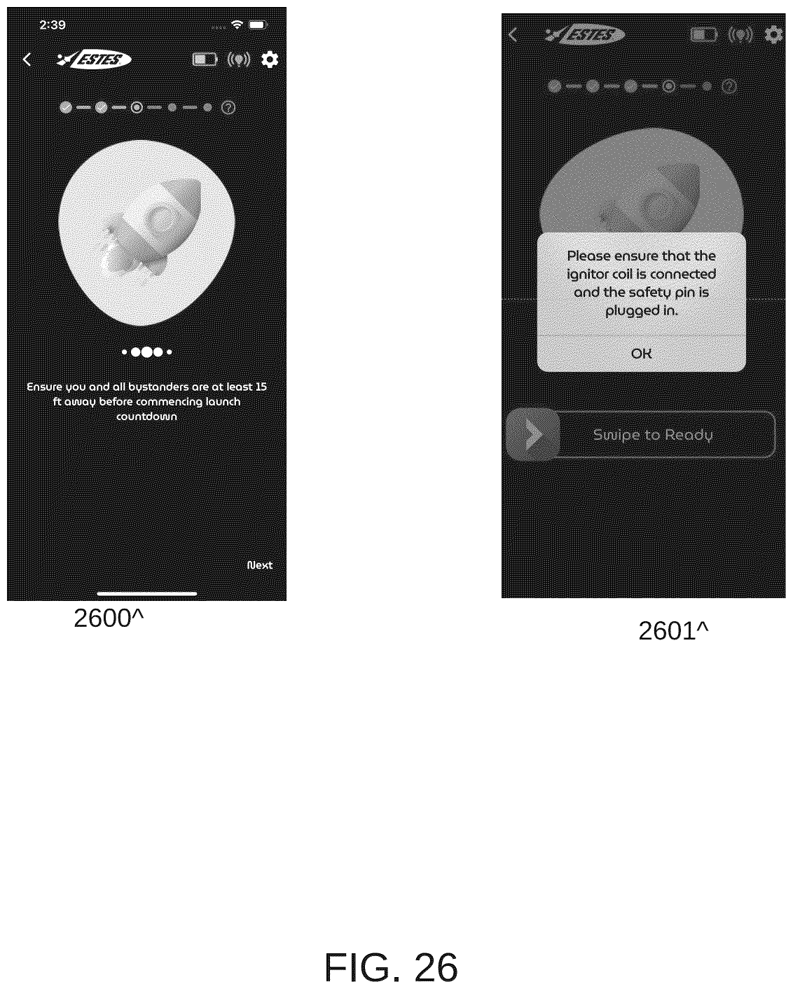

FIG. 26 is a set of screen shots showing example safety messages, according to an embodiment.

Distance prompt screen 2600 informs the user to make sure they keep a safe distance from the rocket. Safety prompt screen 2601 prompts the user to make sure the igniter coil is connected (each end to a respective positive and negative wire on the launcher) and the safety pin (key) is plugged into the launcher. The igniter is a small, electrically activated device used to ignite the rocket engine's propellant. It comprises two main parts: two thin wires, which run from the igniters base and can be connected to wires via alligator clips. When current flows through the wires (e.g., 2.5 amps) it heats up the igniter element. The igniter also comprises an igniter element, at the tip of the igniter there is a small bridge wire or conductive coating (can be made of nichrome) coated with a pyrotechnic material so that when the electrical current is applied, the bridge wire heats up and causes the pyrotechnic material to ignite, which in turn starts the combustion of the rocket engine and causes it to launch. The igniter is inserted into the rocket engine's nozzle so that it can make direct contact with the engine's propellant. When the launcher initiates a launch sequence, it applies the current to the bridge wire which causes the launch.

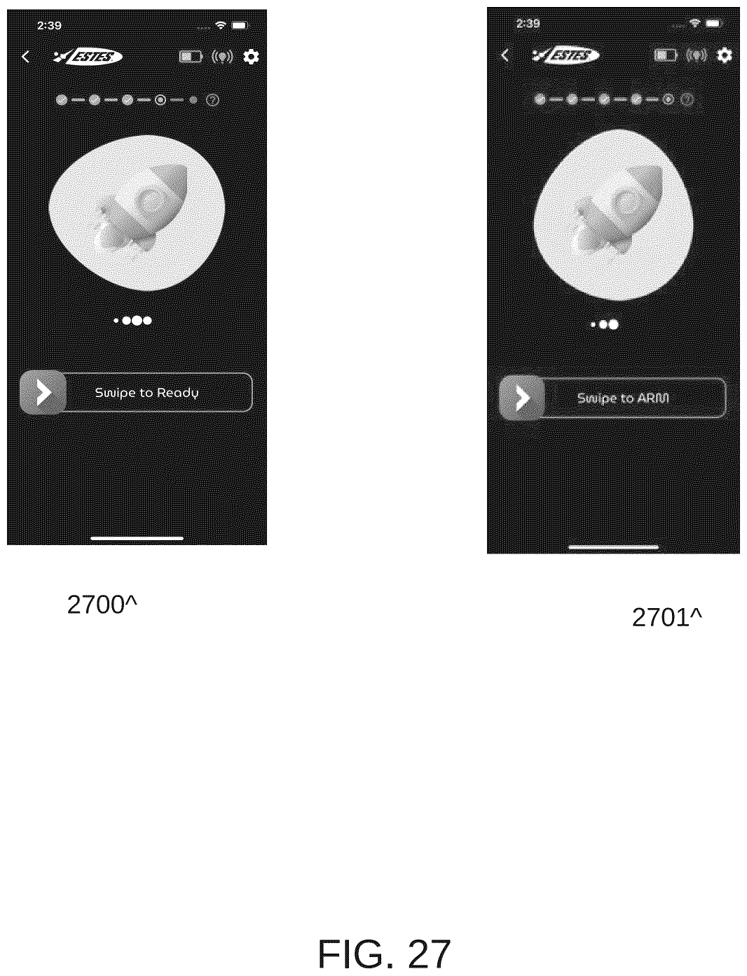

FIG. 27 is a set of screen shots showing example safety check swipes, according to an embodiment.

Swipe to ready screen 2700 enables the user to swipe the cell phone in order to put the phone/launcher in the “ready mode.” Swiping means the user must touch the icon (square arrow) and while touching it, move it in a same direction (e.g., right) in order to successfully switch to the ready mode. The ready mode means that the launcher has passed all or most safety checks but the launcher cannot yet launch the rocket until the launcher is in the “armed” mode. The requirement that the user swipe the phone helps prevent the phone accidentally (e.g., from an accidental touch) being put into the ready mode. Swipe to arm screen 2701 also requires the user to swipe the cell phone (in the same manner as swipe to ready screen 2700) in order to put the rocket/launcher in the “armed” mode. The armed mode means the rocket is all ready to launch.

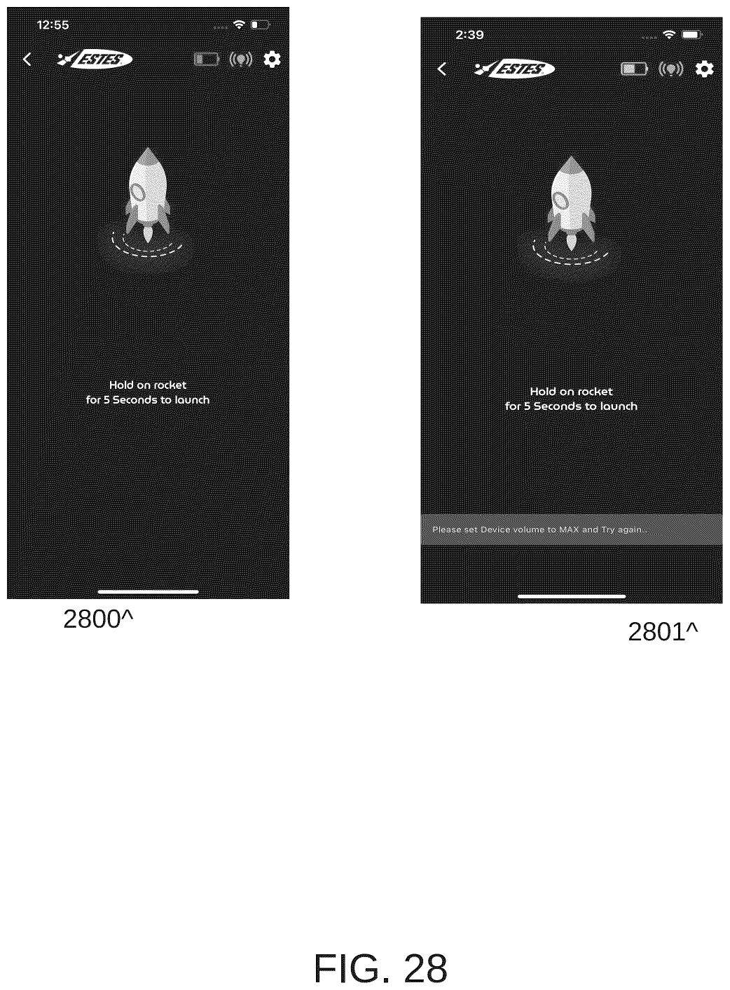

FIG. 28 is a set of screen shots showing example launch messages, according to an embodiment.

Launch screen 2800 enables the user to launch the rocket (when the launcher is in the armed mode) by the user holding down a button on the phone (e.g., a rocket icon) for a predetermined amount of time (e.g., five seconds or any other amount of time). This is required in order to prevent accidental launches. Once the user holds down the button for the predetermined amount of time, (and all other safety checks are successfully performed), then a countdown initiates. If the phone does not have its volume turned up to the maximum volume, then the user can be prompted with volume prompt screen 2801 informing the user that he/she needs to increase the volume on the phone to the maximum possible volume (and the rocket would not launch at this point).

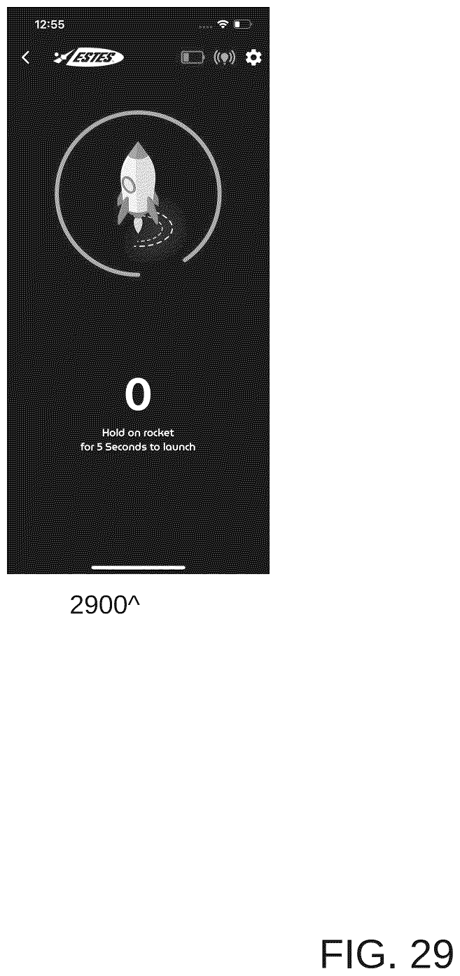

FIG. 29 is a screen shot showing an example of a final launch message, according to an embodiment.

Launch screen 2900 shows the cell phone output after the launch button has been pressed and the countdown has reached 0 (the countdown can start from any number such as 10, 5, etc.). At this point, the rocket would be launched by sending a wireless command to the launcher which then activates current through the wires connected to the igniter which ignites the igniter and thus ignites the rocket engines thereby launching the rocket.

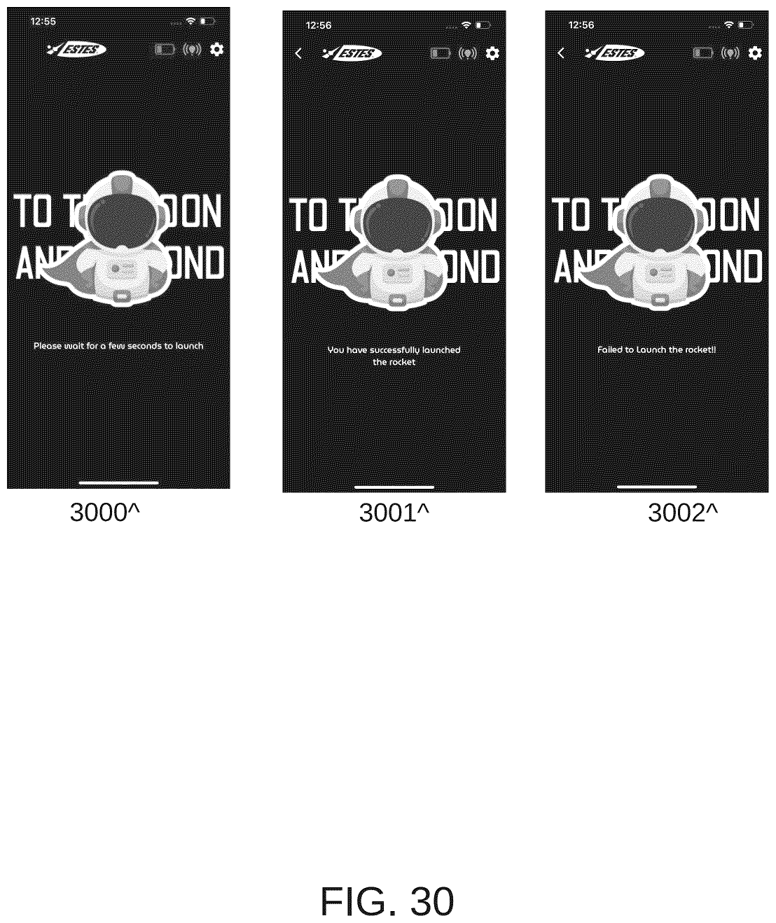

FIG. 30 is a set of screen shots showing launch status messages, according to an embodiment.

In an embodiment, launch delay screen 3000 prompts the user to wait a few seconds for the rocket to launch. This screen can be displayed after the countdown reaches zero. In some implementations, there might be a delay to check some of the safety systems (such as continuity, whether the key is inserted, etc.) and so the launch delay screen 3000 informs the user to wait a short time before the rocket is actually launched.

Launch success screen 3001 is displayed upon a successful launch of the rocket. One way the system can determine if the rocket was successfully launched was to check for continuity between the wires connected to the igniter. If there is no continuity, it can be determined that the igniter burned out and hence the rocket was launched. If there is continuity, then it can be assumed that for some reason, the igniter did not ignite and thus the rocket did not launch.

Launch fail screen 3002 is displayed if, instead of the rocket being launches, a safety check has failed which aborts the launch of the rocket. Such safety checks can include, checking whether the key is inserted into the launcher, checking whether there is continuity between the wires connected to the igniter (e.g., current can pass therebetween), whether there is sufficient distance between the person holding the cell phone and the launcher, and any other safety check.

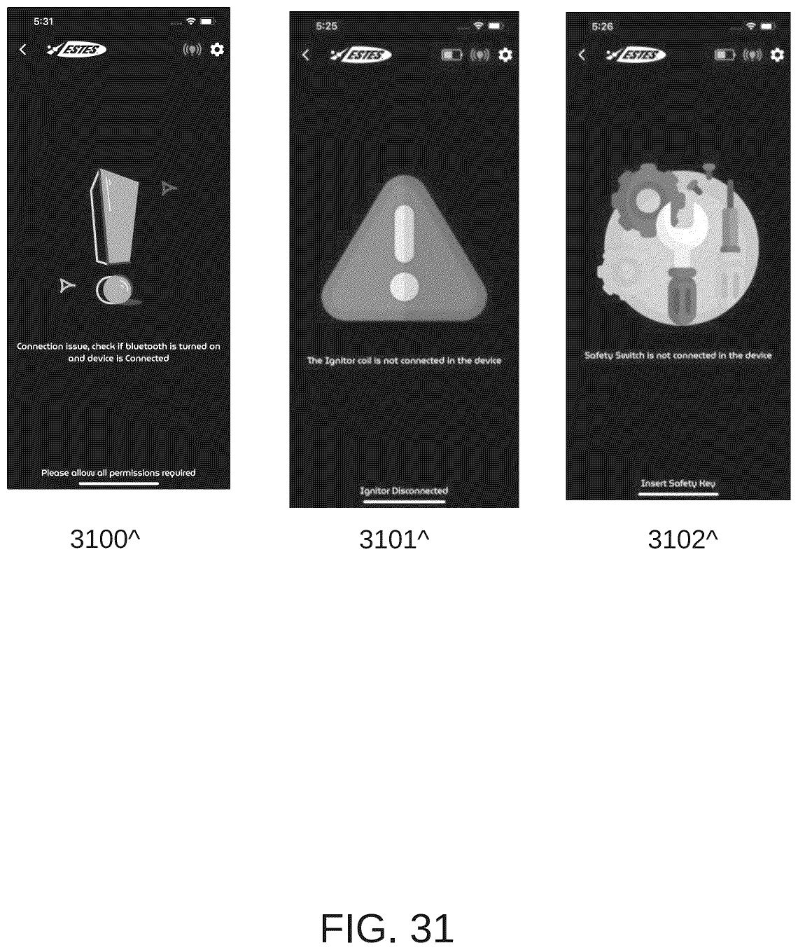

FIG. 31 is a set of screen shots showing launch error messages, according to an embodiment.

First error message 3100 can be displayed when the Bluetooth connection cannot be made. This can happen if the Bluetooth setting isn't turned on, or the launcher′ Bluetooth mechanism is not functioning, etc. Second error message 3101 is displayed when continuity is not present, that is, a current sent through the positive and negative wires connected to the ignitor is not detected. The ignitor leads connect with each other until the ignitor is energized, upon which the wire connecting both leads of the ignitor no longer has electrical continuity (current will not pass between the ignitor leads once the ignitor itself has burned). Thus, pre-launch, there should be continuity between the two ignitor terminals. If not, then second error message 3101 can be displayed. Third error message 3102 indicates that the safety key is not present in the launcher. In order to launch the rocket, the safety key needs to be present the launcher, otherwise second error message 3101 can be displayed and the rocket launch process will not continue.

Thus, there should be continuity (passage of current between the terminals surrounding the igniter) when the rocket is on the launch pad and there should be no continuity (no current able to pass between the terminals) when the igniter has ignited (breaking the electrical connection). Thus, the presence and/or absence of continuity can be used to determine whether the rocket has launched or if there has been some problem (e.g., a failed launch). The continuity test can be a discrete one-time event (checking for the presence of continuity by initiating current through the terminals). Alternatively, the continuity test can be comprised of multiple continuity checks (e.g., 2-10 or more) at various intervals checking for continuity. If any of the continuity checks in the multiple continuity checks embodiment fails (is not what it is supposed to be), then the continuity test is considered to have failed. For example, if the rocket is being armed and a continuity test is performed to ensure continuity, and the test comprises five separate continuity checks, if at least one of these five continuity checks determines that there is no continuity then the continuity check is considered to have failed (no continuity), even if the other checks did find continuity. Similarly, if post-launch, a multiple (5-checks) continuity test is performed, and at least one of these tests finds that there is continuity (even if the other checks result in no continuity) then the test result is that there is continuity and the rocket launch is considered to have failed. Before launch, there is supposed to be continuity, and after launch there is not supposed to be continuity. Continuity between two the two lead wires (which can be the two wires connected to the ignitor) can be checked for in numerous ways. For example, a circuit with a digital input pin, a resistor, and a voltage source, arranged in a voltage divider configuration. One lead is connected to a digital input pin of a microcontroller, while the other lead is connected to ground through a resistor. A known voltage source, such as the microcontroller's internal pull-up resistor or an external voltage source, can be applied to the lead connected to the input pin. When continuity is present between the two leads, the circuit is closed, resulting in a detectable voltage at the input pin that the microcontroller registers as a ‘HIGH’ signal. In the absence of continuity, the circuit remains open, and the input pin reads a ‘LOW’ signal. This configuration enables the microcontroller to determine continuity based on the presence or absence of the signal. Any other way to check for continuity can be utilized as well.

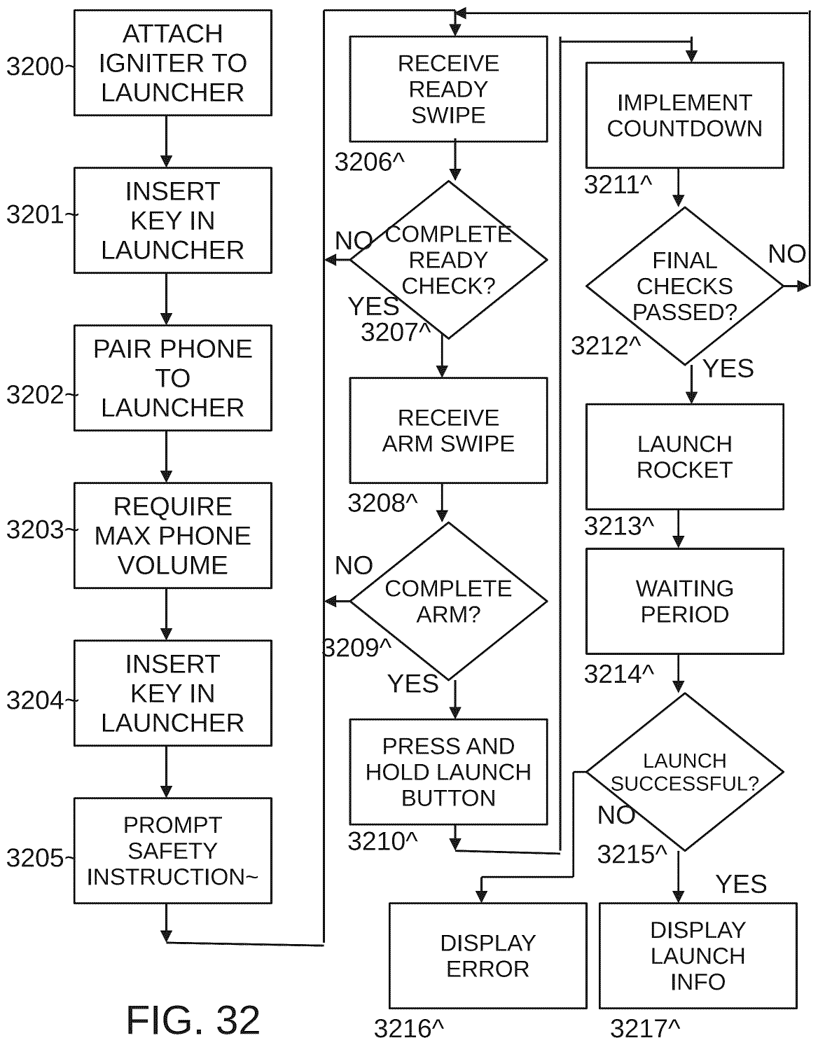

FIG. 32 is a flowchart illustrating an exemplary method of implementing a rocket launch, according to an embodiment. The launch method illustrated in FIG. 32 is an alternative to the method illustrated in FIGS. 15-16, or elements of FIG. 32 can be combined with FIGS. 15-16. Note that the method illustrated in FIG. 32 (as well as the other flowcharts) can be implemented by the app running on the cell phone, in conjunction with the launcher (in wireless communication with the cell phone), and also in conjunction with any remote servers that can be part of the launch process.

In operation 3200, the user attaches the igniter to the launcher. This comprises inserting the igniter into the engine which is located inside the rocket on the launcher. The user then connects a positive terminal (typically red wire) to one lead wire of the igniter and the negative terminal (typically black wire) to the other lead wire of the igniter. The igniter typically does not have a polarity, thus it does not matter which wire is connected to which side of the igniter.

From operation 3200, the method proceeds to operation 3201, in which the user inserts the key into the launcher. The key is typically a simple metal pin which completes a circuit inside the launcher, thereby enabling detection that the key is present. The key is a safety mechanism so that the rocket would not launch unless the key is present.

From operation 3201, the method proceeds to operation 3202, wherein the user pairs the user's cell phone with the launcher. The launcher would typically have its own wireless communication module (can be Bluetooth, Wi-Fi, etc.) that would communicate with the user's cell phone. During operation of the launch app (or referred to herein as simply the “app”) running on the user's cell phone, the app would search for the Bluetooth signal of the launcher. Once found, the user can then enter a pairing code to confirm that the user is authorized to pair to the launcher (so a bystander cannot pair their Bluetooth device with the launcher). The pairing code can be provided to the user and can be printed on the launcher itself. Once the cell phone is paired to the launcher, then communications can be transmitted between the cell phone and the launcher (in both directions).

From operation 3202, the method proceeds to operation 3203, which requires the volume on the cell phone to be turned up to the maximum volume possible. The cell phone volume should be turned up to the maximum volume to ensure that the countdown and other audible signals can be heard. In some cases, the app can automatically control the cell phone's volume and turn it up to the maximum volume. In other cases, it is up to the user to manually turn the volume up to the maximum volume. The app can typically check the cell phone's volume level to ensure that the volume level is set to the cell phone's maximum possible volume. If the volume level is not set to max volume, during a ready check (and also the arm check) the method typically would not continue.

From operation 3203, the method proceeds to operation 3204, in which the user inserts the key into the launcher. The key is typically a metal (conductive) pin that inserts into a hole in the launcher. Conductive terminals are on the inside of the hole so that the key simply makes a conductive connection between the terminals, thereby providing conductivity (completing the circuit path) and this is how the system can determine whether the key is inserted into the launcher or not.

From operation 3204, the method proceeds to operation 3205, which prompts the user safety instructions. The app would display safety instructions (see FIG. 26).

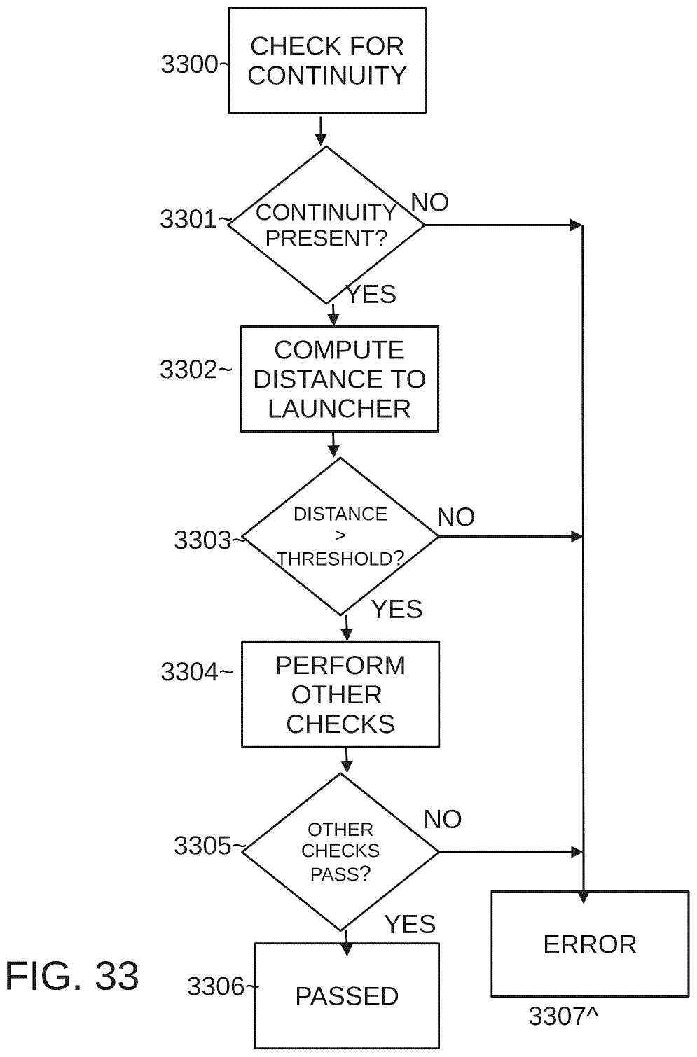

From operation 3205, the method proceeds to operation 3206, in which the app waits for the user to swipe on the cell phone screen for a ready check. A ready check is a check performed to ensure that the rocket is ready for arming. A swipe is where the user takes his/her finger and touches an icon on the screen and swipes across the screen in a straight line. This can help prevent situations where the screen is accidentally touched. When the ready swipe is received in operation 3206, then the ready check is performed. FIG. 33 illustrates one example of performing the ready check. FIG. 27, screen 2700 shows an example interface with a swipe to ready functionality (the user would touch the square and slide it to the right to successfully complete the swipe).

From operation 3206, the method proceeds to operation 3207 (once the ready swipe is received) and determines whether the ready check has been successfully completed. If not (e.g., there was an error in the ready check, then the particular error would be displayed to the user and the method would return to operation 3206). If in operation 3207, the ready check was completed successfully, then the method proceeds to operation 3208. The app would store the status (e.g., a Boolean flag) of whether the ready check has been successfully completed.

As part of the ready check, a check can be performed for unsatisfactory weather conditions. For example, if there are overly dry conditions, (e.g., low humidity, dry soil, etc.) a warning can be displayed to the user or optionally the system can prevent launch. Overly dry conditions (e.g., fire danger ratings) can be detected from a national weather service, or input from the user, and might be more likely to cause a fire upon ignition. Alternatively, a hygrometer can be used to measure humidity (below 30% can be considered dry).

Note that the app can request information from a remote server regarding actual real-time conditions of the location where the rocket launcher is located (or within a predetermined distance/radius from where the rocket launcher is located such as a one mile radius from the rocket launcher). The app can automatically determine the location of the rocket launcher (for example using GPS data on the rocket, launcher, or cell phone) and transmit this location to the remote server so that the remote server can respond with real-time conditions relating to the location. The remote server can be maintained by a government or private organizations, such as FAA, national weather service, fire marshall, etc. The information can be relevant to whether a rocket launch should be conducted at the current location of the rocket launcher at the current time. For example, the FAA may maintain flight bans over certain areas at certain times and so if the FAA server is queried, information regarding potential flight bans over the current location (local condition data) can be retrieved and displayed on the app so that the user can determine whether to proceed with the launch or not. The remote server can also be the Fire Marshal (or other agency related with prevention of fires) and the local condition data can be conditions such as overly dry conditions which would result in a launch not being recommended. The remote server can be a weather service (maintaining nationwide or local weather) and the local condition data can be current weather conditions (e.g., wind speed, temperature, etc.) and the user can determine whether or not to launch based upon these local conditions. The remote server(s) can be queried automatically and the local condition(s) can also be displayed on the app automatically in order to provide the user with relevant information about whether to launch or not.

In operation 3208, the app then prompts the user to swipe to arm. After the ready check has been completed, the rocket is still not ready to launch because the rocket has not been armed yet. Once the rocket is armed, then the rocket can actually be launched off the launcher. In operation 3208, the app waits for the user to swipe to arm (in the same fashion as swiping to ready). FIG. 27, screen 2701 shows an example swipe to arm interface, in which the user would touch the square and slide it to the right to successfully complete the arm swipe.

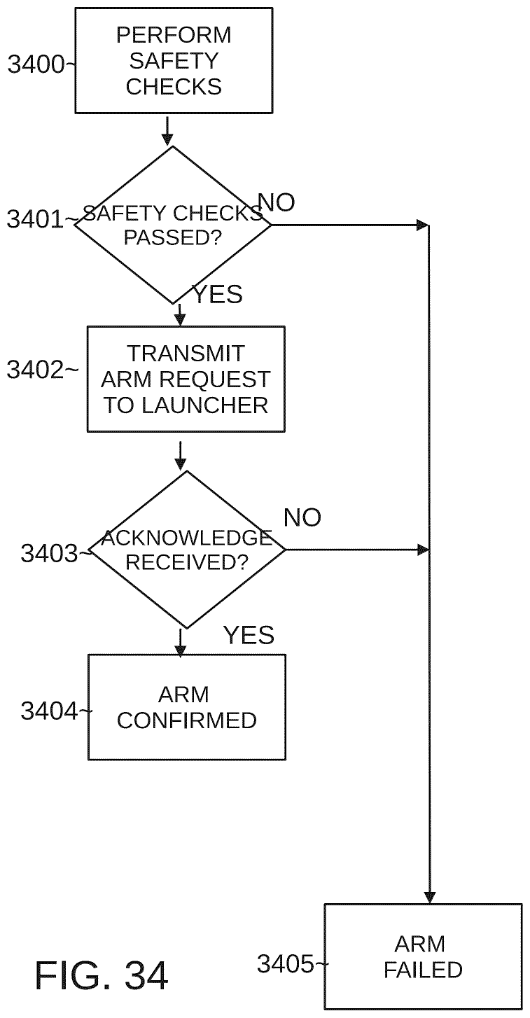

After the arm swipe is received in operation 3208, the method then performs the arm check (see FIG. 34) and proceeds to operation 3209. If the arm check fails, the method returns back to operation 3206 which requires the user to perform the ready swipe (and hence the ready check) all over again. An error message would be displayed to the user to inform the user what went wrong with the arm check.

If in operation 3209, the arm check has succeeded, then the method proceeds to operation 3210, which arms the rocket and proceeds to display a launch screen on the cell phone (see FIG. 28, launch screen 2800). A confirmation is wirelessly transmitted to the launcher to inform the launcher that it is now armed and that it can launch the rocket when it receives the proper command. If the launcher is not armed, then it would not ignite the igniter no matter what command it receives, as the launcher must be in the “armed” mode in order to ignite the igniter and launch the rocket. A flag can be maintain to store the status of the arm check (whether the rocket is armed or not), e.g., when the arm check is successfully passed then the rocket is armed, otherwise the rocket would not be armed. The launcher would also store this flag to know its status (whether it is armed or not). If the launcher is not armed, and someone hacked into the launcher and would be able to transmit a launch command, the launcher would still not launch the rocket because the launcher is not in the armed mode. Note that when the launcher is armed, the launcher itself can be triggered to make sounds and display lights in order to indicate to all bystanders that the launcher is armed and everyone should keep their distance from the launcher.

The user must hold down a button (e.g., a rocket shape or any other shape) for a predetermined amount of time (e.g., five seconds) in order to advance to the countdown.

Once the user has held the launch button down for the predetermined amount of time in operation 3210, the method proceeds to operation 3211, which implements the countdown. A countdown is displayed on the cell phone, counting down from 5 (or other number) to 0. The cell phone also speaks (using the cell phone's speaker) the countdown number (and the volume is set to max volume). A signal is transmitted to the launcher to cause the launcher to also output sounds (e.g., beep and/or also broadcast the audible countdown directly from the launcher). This serves as a warning to anyone located near the launcher to move away. When the countdown reaches zero, the method then performs a final safety check. The final safety check can comprise all of the checks performed during the ready check and the arm check (or any combination of the individual checks performed therein). For example, there must be continuity in the igniter before proceeding to operation 3213, so another continuity check can be performed just before launch. If this final continuity check fails (no continuity) then the method can return to operation 3206, while of the final continuity check passes (continuity) then the method can proceed to continue to launch. When all additional pre-launch checks are successfully completed, the method proceeds to operation 3212.

If in operation 3212, all of the final checks are not passed, then the method can return to operation 3206 which requires a ready swipe all over again (any flags that confirmed the ready check and the arm check were successfully completed would be reset). If in operation 3212, all of the final checks are passed (including the ready check and arm check were both previously passed), then the method proceeds to operation 3213.

In operation 3213 the rocket is launched. A launch command is transmitted from the cell phone to the launcher. The launch command can be a simple code (e.g., byte or string) transmitted to the launcher, which the launcher receives and verifies. Note that all communications/commands transmitted from the cell phone to the launcher (and also from the launcher to the cell phone) would typically be transmitted wirelessly (e.g., Bluetooth, BLE, Wi-Fi, or any other such wireless protocol). When the launcher receives and verifies the launch code, the launcher must first verify that the launcher itself is in the armed mode. If the launcher is not in the armed mode, the launcher would not ignite the igniter and the rocket would not launch, and an error message can be transmitted to the portable communications device. If the launcher is in the armed mode, then in response to receiving the launch code from the portable communications device, the launcher then sends a current (e.g. 2.5 amps or other suitable current) to the igniter (e.g., by energizing a pin connected to the igniter) which burns the igniter which ignites the engine and causes the rocket to launch.

From operation 3213, the method proceeds to operation 3214, which waits a period of time (e.g., five seconds) before determining whether the launch was successful. This enables any electronics to reset and accurate measurements can be taken.

From operation 3214, the method proceeds to operation 3215, which determines whether the launch was successful. This can be done by performing numerous checks, including a continuity check of the terminals leading to the igniter. When a continuity check is performed, the app transmits a signal to the launcher to check for continuity, n which the launcher itself checks that a current can (or is) passing through the igniter terminals. If the current is passing through the igniter (there is continuity), there is continuity meaning the igniter is hooked up correctly and that the igniter has not ignited yet. If the current is not passing through the igniter (there is not continuity) then the igniter is not hooked up yet or the igniter has burned out (the rocket has launched). If there is continuity, then the rocket has not launched. If there is not continuity, then considering that there was continuity a shot duration ago (at the end of the countdown and the other pre-launch checks), this means that the rocket most likely has launched.

If in operation 3215, it is determined that the launch was successful, then the method proceeds to operation 3217, which displays on the app that the launch was successful. Tracking can be performed, for example, there can be a GPS device located inside the rocket (in communication with the app and/or remote server via a cellular phone connection) which transmits location data of where the rocket is currently located. The location can be displayed to the user (e.g., using a map) so the user can track where the rocket is currently located.

If in operation 3215, it s determined that the launch is not successful, then the method proceeds to operation 3216, which displays that the launch was not successful and displays the particular reason why (e.g., the igniter dd not ignite, etc.) The system would not remove the “armed” status and also remove the “ready” status and return to operation 3206 so that the user can try again.

FIG. 33 is a flowchart illustrating an exemplary method of performing a ready check, according to an embodiment. This method can be performed in operation 3207 from FIG. 32.

In operation 3300, a continuity check is performed. The app would send a wireless request to the launcher (via Bluetooth since the two devices are paired together) requesting to check for continuity. If there is a continuous circuit between the two leads connected to the igniter then there is continuity, otherwise there is not continuity. A small current can be passed through one of the leads and if the circuit is completed, then continuity is established but if the circuit is not completed then the continuity fails.

From operation 3300, the method proceeds to operation 3301, which is a decision block. If continuity is not present, then the method proceeds to operation 3207, which outputs an error to the user. If in operation 3301, continuity is present, then the method proceeds to operation 3302.

In operation 3302, a distance from the user (holding the cell phone running the app) to the launcher is computed. This can be performed in numerous ways. For example, the GPS coordinates of the cell phone can be determines using the cell phone's GPS system, and the launcher can also have its own GPS chipset in order to determine the location of the launcher. The difference between the two locations (the location of the cell phone running the app and the launcher) is the computed (e.g., by subtraction). A threshold distance can be determines which is a minimum distance that the user (with the cell phone) must be from the launcher. The threshold can be determined in real time and can be based upon the engine in the rocket being launched. For example, the app can require the user to enter the model of rocket (and/or the type of engine being used). Larger engines would require more distance from the launcher. For example, Table I below lists rocket engine types and their respective distance thresholds.

### Table I

### Rocket Engine Class Threshold Distance

A, B, C, D 15 feet
E, F, G 30 feet
H, I 100 feet
J, K, L, and beyond 500 feet

Once the system knows the rocket engine type, it can look up the threshold distance using a table (or data structure).

From operation 3302, the method proceeds to operation 3303, which determines whether the distance between the users (spectators) is greater than the threshold distance. It is assumed that all spectators are standing with the user holding the cell phone, and thus the distance is measured from the cell phone.

In another embodiment, instead of (or in addition to) using the GPS data described above, the user can be required to take a picture of the launcher (using the cell phone running the app). The all would then analyze the picture and determine the distance the launcher is from the phone. This can be done by identifying the rocket launcher (using pattern recognition such as a convolutional neural network), and then determining the size of the launcher (by comparing the size to a predetermined baseline size), and then determining the distance of the launcher based on the size (the smaller the size, the further away the launcher). Thus, the distance (used to compare to the threshold) can also be determined this way.

If in operation 3303 the distance is not greater than the threshold (determined in operation 3302), then the method proceeds to operation 3307 which displays an error to the user. If in operation 3303, the distance is greater than the threshold, then the method can proceed to operation 3304.

In operation 3304 other checks can be performed. For example, a physical key fob can be required in order to pass the ready check. The key fob can be held up to the cell phone running the app, when the key fob is detected, then a flag can be set that the key fob was detected. This can occur at any time during the launch process (e.g., during the ready check or before). The key fob can be a near field communication tag, which is a uses a wireless short range communications protocol.

A Near Field Communication (NFC) tag operates as a specialized form of Radio Frequency Identification (RFID), typically functioning a at a frequency of 13.56 MHz. When the NFC tag is brought within a close range (typically less than 4 cm) of the cell phone, the phone's electromagnetic field induces a small current in the tag, powering its passive RFID circuitry. This enables the tag to transmit its stored data, such as a unique identifier or security key, back to the cell phone. The cell phone's NFC reader captures this data using short-range radio communication and passes it to the app. The app then processes the identifier, verifies it against stored credentials, and if it matches, authorizes the user and sets a NFC flag to “pass” (which would start out at fail). Since the tag must be in close proximity to the cell phone running the app, it would be impossible for a hacker to hack into the system and launch the rocket remotely. Once the flag is passed, it can remain as passes during use of the app and the user would not have to present the tag to the phone again.

So in operation 3304-3305, other safety checks can be performed (such as confirming that the NFC tag was successfully presented to the cell phone). Operations 3204-3205 can be performed for each additional safety check that may be performed during the ready check. If in operation 3305, the safety check was passed (e.g., the NFC tag was successfully presented), then the method proceeds to operation 3306, which results in a ready check pass. A flag is set that the ready check has been passed so that the launch process can continue.

In a further embodiment, instead of using an NFC tag to authenticate the user of the mobile communications device, a passcode system can be used. A unique passcode can be printed on the launcher itself, and the app can prompt the user to enter the passcode. If the user enters the passcode correctly, then the user will be authenticated and the launch process can continue, while if the passcode is not entered correctly, the launch process cannot proceed (e.g., cannot pass the ready check and/or arm check) until the passcode is entered successfully. In this way, an unaffiliated bystander would not be able to pair his/her phone with the launcher, as one would need to be in close proximity to the launcher to be able to read the passcode printed therein.

If in operation 3305, any of the other safety checks were not passed, then the method proceeds to operation 3307, which results in an error (the cause of the error would be displayed to the user in the app). In operation 3307, a flag is set that the ready checked failed and the launch process cannot continue until the error is addressed and then the entire ready check is successfully completed.

FIG. 34 is a flowchart illustrating an exemplary method of performing an arming check, according to an embodiment. An arm check is another set of safety checks performed after the ready check and just before the launch.

In operation 3400, safety checks are performed. This can be a set of safety checks, such as all of the same safety checks that were performed in FIG. 33 for the ready check. In addition, there can be additional safety checks that can be performed in the arm check that were not performed in the ready check.

From operation 3400, the method proceeds to operation 3401, which determines whether the safety checks were passed. If the safety checks were all not passed, then the method proceeds to operation 3405, in which the arm operation fails and the launch cannot proceed.

If in operation 3401, all of the safety checks have passed, then the method proceeds to operation 3402, which wirelessly transmits (e.g., Bluetooth) a request to the launcher to arm. When the launcher receives the request to arm, the launcher will then transmit an acknowledgement back to the app confirming the arm request as been received. The launcher also then puts itself in the armed mode, by setting a flag indicating that the launcher is armed (before being armed the arm flag would be set to unarmed). The processor on the launcher can run instructions independently (and in conjunction with) the processor on the app.

From operation 3402, the method proceeds to operation 3404, which determines whether the acknowledgement sent by the launcher has been received by the app. If the acknowledgement has not been received, then it is not known whether the launcher received the arm request or not and the arm check fails, and the method proceeds to operation 3405.

If in operation 3403, the acknowledgement is received (wirelessly via Bluetooth or other wireless protocol), then the method proceeds to operation 3404, wherein the arm check is successfully completed. The arm flag is set to armed mode, meaning the rocket is ready to launch.

In operation 3405, the arm flag is set to fail (and the ready flag would also be set to fail) and an error is displayed to the user. The user will have to correct the error and perform the ready check and the arm check all over again to launch the rocket.

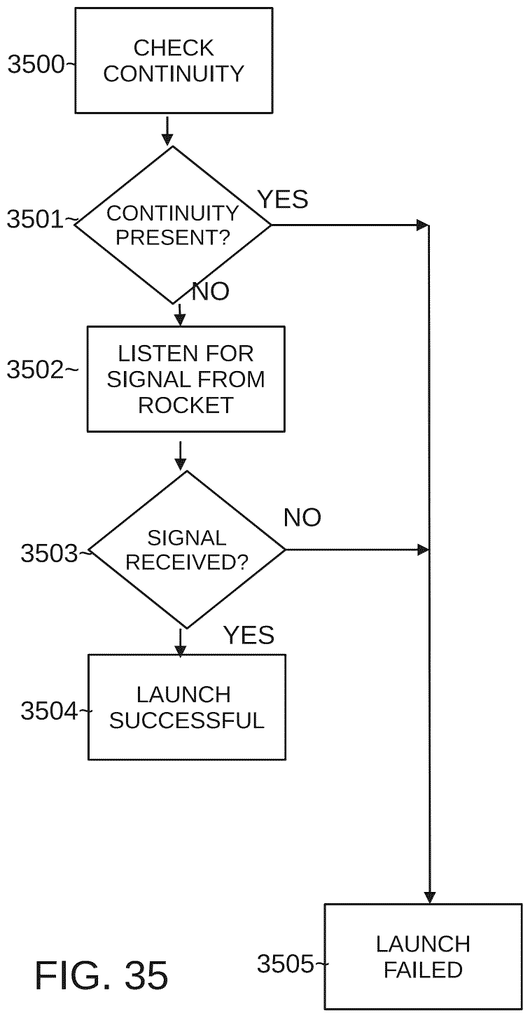

FIG. 35 is a flowchart illustrating an exemplary method of post launch checks, according to an embodiment. After the app sends the signal to the launcher to launch the rocket (in operation 3213) and then after the waiting period (in operation 3214), the app determines performs the launch checks in FIG. 35 to determine if the launch was successful.

In operation 3500, continuity (“continuity” as used herein refers to whether the two leads to the igniter are connected thus forming a continuous circuit) is tested for. This can be done as described herein, for example passing a current to one of the leads to see if the circuit completes.

From operation 3500, the method proceeds to operation 3501, which determines whether the continuity was present. If continuity is present (the circuit is complete) then the method proceeds to operation 3505 in which the launch has failed and the rocket is presumably still on the launcher.

If in operation 3501, continuity is not present (presumable the igniter has ignited which destroys the continuity between the terminals), then the method proceeds to operation 3502, which can listen for a wireless signal from the rocket (direct or indirect signal). For example, the processor on the rocket can have a cellular data capability in which a signal is transmitted to a remote server that the rocket has launched and the respective GPS coordinates (which can be periodically transmitted, for example every second). This data can be transmitted to a remote server which is in communication with the app, and this data can then be transmitted from the remote server to the app. Alternatively (or in addition to), a wireless signal can be directly transmitted from the rocket to the app indicating the rocket has launched and its periodic GPS coordinates. This can be done via Bluetooth, although since Bluetooth may have a limited range, alternative wireless protocols can be utilized, such as wi-fi, Zigbee, LoRa, etc.) to transmit directly (or indirectly) to the app running on the cell phone.

From operation 3502, the method proceeds to operation 3503, which determines if a signal is received from the rocket. If no such signal has been received from the rocket confirming a successful launch, then the method can proceed to operation 3505, which indicates to the user that the launch has failed and the reason why the app believes the launch has failed (continuity still present, no signal from rocket, etc.)

If in operation 3503, it is determined that the signal from the rocket has been received, then the method proceeds to operation 3504, which displays a message on the app that the rocket has launched. Additional launch information can be displayed on the cell phone, for example if the rocket is continuously transmitting GPS data, a map can be displayed on the cell phone which show the real time position of the rocket.

The launcher contains hardware including the physical launch pad for the rocket as well as the electronics to facilitate the coordinate launch process as described herein.

FIG. 36 is a block diagram illustrating electronic hardware comprising a launcher, according to an embodiment.

The launcher can include any physical structures 3606 (e.g., launch pad, launch rod, blast deflector plate, key hole, and any other structures). The launcher can also comprise a processor 3600 (which can be a microcontroller such as an ESP32, etc.). The processor 3600 can also be connected to a key circuit 3601 which detects the presence of the key (as described herein), as the key has a metal pin which would complete a circuit when inserted. The processor 3600 can detect the presence or absence of the key inside a key hole inside the launcher. The processor 3600 can also be connected to a continuity checker 3602 which (as described herein) can check for the continuity of the leads inserted into the igniter. The processor 3600 can also be connected to a ROM/RAM which are used for the operation of the processor 3600. The ROM can contain code facilitate operations, such as an operating system, code to implement all of the features implemented by the launcher, etc.) The processor 3600 can also be connected to a wireless interface 3603 which can communicate with external devices via any wireless protocol, such as Bluetooth, Bluetooth Low Energy, Wi-Fi, Zigbee, LoRa, etc. For example, wireless interface 3603 can be programmed to pair with the cell phone so that the cell phone (and more particularly the app running on the cell phone) can communicate directly with the launcher (in both directions). The RAM can be utilized to maintain data needed for the operation of the code herein, including flags, variables, stacks, etc. The processor 3600 can also be connected to any input/output device(s) 3605, such as LEDs (e.g., which indicate the status of Bluetooth pairing), speaker (which can make noise such as buzz when the countdown is occurring and can also play the spoken countdown), etc. The processor 3600 can also be connected to a non-transitory storage 3607 (e.g., hard disk, EPROM, flash drive, solid-state drive, hard disk drive, memory card, etc.) which includes both the respective non-transitory storage medium (e.g., the hard disk, etc.) and the respective physical reading device (e.g., the disk drive, etc.) The non-transitory storage medium would store computer readable instructions, that when executed by the processor 3600, would implement all of the features that the launcher can perform. The processor 3800 can also be connected to a GPS locator 3608 which can provide the GPS coordinates for the launcher, which can be transmitted to the app so that the app can determine how far away the launcher is. An igniter triggering circuit 3609 is used to ignite the igniter by sending a current (which can be connected to a pin on the processor 3600) to the igniter triggering circuit 3609 which can be connected to the terminals connected to the igniter. Transistor(s) can also be used to increase the current sent to the igniter wires to ensure the igniter ignites when commanded to. The processor 3600 can also be connected to a camera (video or still) which can take pictures of the rocket and the launch which can be transmitted via the wireless interface 3603 to the mobile phone running the app, and/or a remote server storing launch data. The camera can also be used to scan a barcode (or other indicia) or use optical recognition in order to determine an engine type used for the launch, as well as the model of rocket being used. Alternatively, a barcode scanner can be connected to the processor 3600 in order to determine the type of engine being used (which can be marked with a barcode indicating the engine type).

The rocket itself can optionally have an electronic system as well, which can be used for tracking and safety checks.

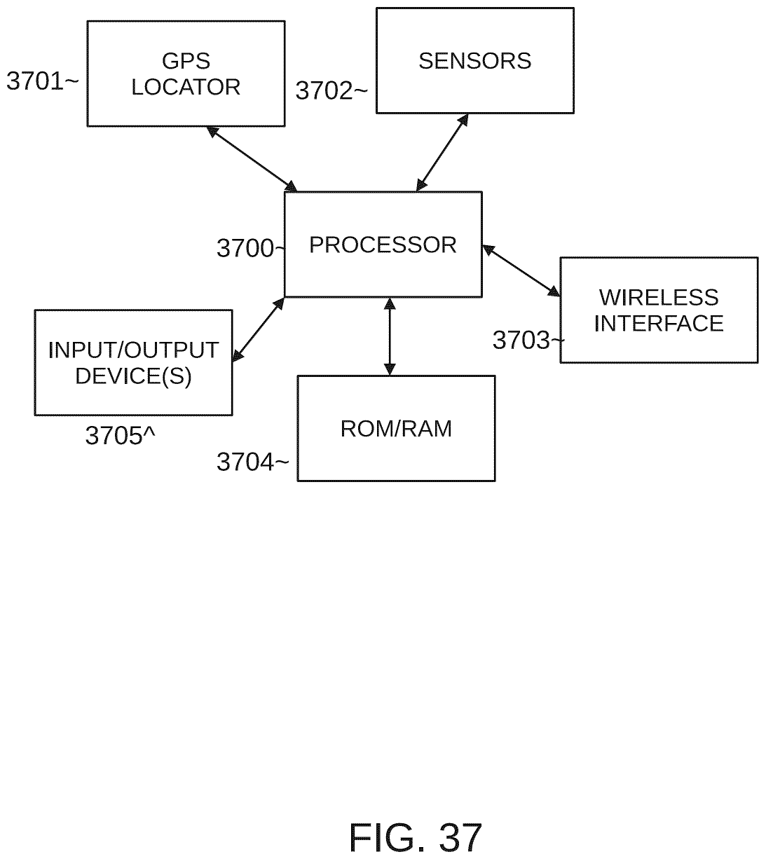

FIG. 37 is a block diagram illustrating electronic hardware located inside the rocket itself, according to an embodiment.

A processor 3700 can me a microcontroller such as an ESP32 (or any other suitable microcontroller). The processor 3700 is connected to a GPS locator 3701 which can determine the rockets current physical location (which can be transmitted to a remote server such as remote server 1803). The processor 3700 can also be connected to a wireless interface 3703 which can communicate wirelessly with external devices using any wireless protocol, such as Bluetooth, Bluetooth Low Energy, Wi-Fi, Zigbee, Lora, etc. The processor 3700 can also be connected to a non-transitory storage 3707 (e.g., hard disk, EPROM, flash drive, solid-state drive, hard disk drive, memory card, etc.) which includes both the respective non-transitory storage medium (e.g., the hard disk, etc.) and the respective physical reading device (e.g., the disk drive, etc.) The non-transitory storage medium 3707 would store computer readable instructions, that when executed by the processor 3700, would implement all of the features that the rocket can perform (e.g., periodically transmit GPS location, etc.) The processor 3700 can also be connected to sensors 3702 which can include any type of physical sensor, such as gyroscope (can measure angular velocity), magnetometer, accelerometer, altimeter, pressure sensor, thermometer, barometer, pressure sensor, etc. Readings from any/all of these sensors can be digital and transmitted periodically via the wireless interface 3703 to a remote server for logging and display to authorized users. The processor can also be connected to a video camera (not pictured in FIG. 37) which can capture, record and transmit video from the rocket (e.g., of the earth). The processor 3700 can also be connected to a ROM/RAM 3704 which are used for the operation of the processor 3600. The ROM can contain code facilitate operations, such as an operating system, code to implement all of the features implemented by the launcher, etc.) The processor 3700 can also be connected to an input/output device(s) 3705 which can comprise a speaker which can emit audible signals, lights (controlled by the processor), etc.

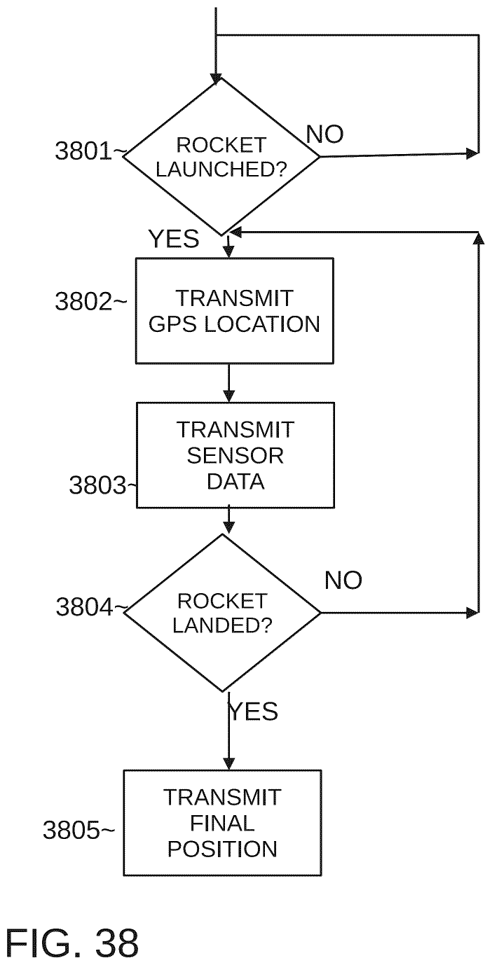

FIG. 38 is a flowchart illustrating an exemplary method of transmitting positional and sensor data from a rocket, according to an embodiment. The methods in FIG. 38 are performed by the hardware located on the rocket itself, such as that illustrated in FIG. 37.

In operation 3801, it is determined whether the rocket has been launched. This can be done (after a successful launch sequence) by checking to see if there is continuity between the ignitor terminals, as described herein. If the rocket has not yet launched, then the method can keep checking in operation 3801 until the rocket has launched.

If the rocket has successfully launched in operation 3801 (there no longer is continuity between the ignitor terminals), then the method proceeds to operation 3802, which transmits the GPS location of the rocket via a wireless protocol (e.g., Lora, Zigbee, cell phone data, etc.) The GPS location can be obtained by a GPS module 3701 located on the rocket itself. The transmission can be to a particular recipient (e.g., a particular IP address, a particular cell phone number, a particular email address, a particular MAC address, etc.) or the transmission can just be a general broadcast of the GPS information.

From operation 3802, the method proceeds to operation to operation 3803, which transmits sensor data (e.g., readings from a gyroscope (can measure angular velocity), magnetometer, accelerometer, altimeter, pressure sensor, thermometer, barometer, pressure sensor, etc.) The readings can be converted into digital form before being transmitted. The transmission of the sensor data can be to a particular recipient (e.g., a particular IP address, a particular cell phone number, a particular email address, a particular MAC address, etc.) or the transmission can just be a general broadcast of the data.

Note that in operation 3803, other data can be transmitted as well. For example a camera (still or video) can be attached to the processor 3700 and pictures and/or video can be captured and transmitted wirelessly so that the pictures and/or video can be retrieved by the user(s) who launched the rocket (and used to make a multimedia clip, etc.) All of the data transmitted in operations 3802 and 3803 can be transmitted to a remote server/database and stored on the database where it can be retrieved by any authorized user (e.g., the user who launched the rocket). The app knows the username of the user and so the data from the rocket can be transmitted along with the username (or other unique identifier referring to the username's account) so that all of the data transmitted can be stored in a record(s) associated with the account of the username. In this way, the user using the username's account can retrieve all of the data (e.g., pictures, video, GPS location over time, sensor data over time, etc.) and all of this data can be used to create a multimedia clip.

From operation 3803, the method proceeds to operation 3804, which determines whether the rocket landed. This can be done in a number of different ways. For example, an altimeter connected to the processor 3700 can be checked (after the rocket has achieved at least a minimum height or a predetermined amount of time has elapsed after launch in order to avoid the rocket thinking it has landed when it has just taken off) and if the altitude is below a certain level (e.g., 25 feet) then it can be assumed the rocket has landed. If in operation 3804, it is determined that the rocket has not yet landed, then the method returns to operation 3802 which continues to transmit data.

If in operation 3804, it is determined that the rocket has landed, then the method proceeds to operation 3805, in which the rocket can transmit its final GPS position and it can cease transmitting data.

In a further embodiment, after a rocket launch, a media clip can be automatically generated (by the app, or by a remote server) utilizing any combination of data logged during the rocket flight (e.g., still pictures taken by the rocket or launcher, video taken by the rocket or launcher, sensor data, etc.). For example, a video of the rocket launch can be combined with video taken from the rocket itself and the path of the rocket can be drawn on a map, along with sound effects and animation, creating a visually appealing and informative video clip pertaining to the rocket launch. The video clip can then be posted to social media sites so that other people can view the clip.

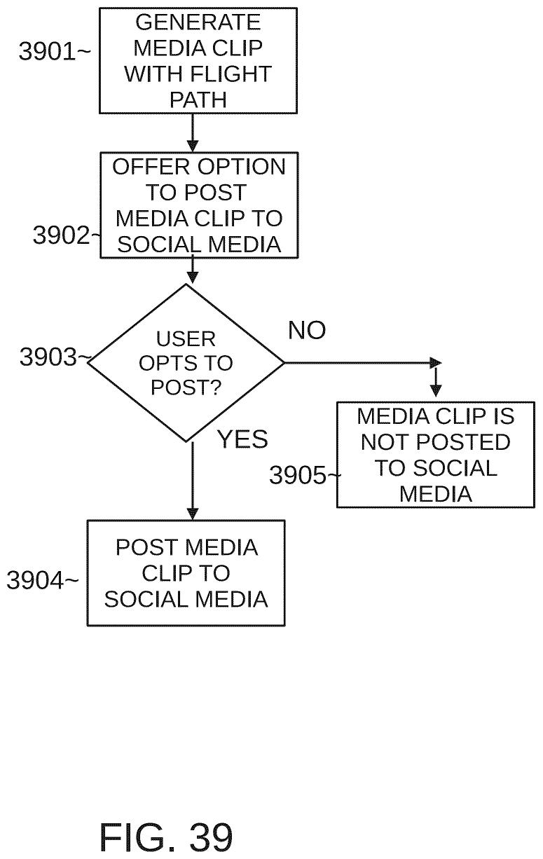

FIG. 39 is a flowchart illustrating an exemplary method of generating and posting media clips, according to an embodiment.

In operation 3900, a media clip is generated utilizing the flight path. The flight path is obtained from the GPS data that was transmitted by the rocket itself. The clip can also incorporate any other assets, such as pictures and/or video taken by the launcher, rocket or the app. The video clip can also incorporate pictures of the actual rocket, and/or animations of the rocket utilizing sensor data, for example positional data, tilt, altitude, etc. So a computer generated rocket can be generated showing the flight path and attitude of the rocket along the flight path using real data transmitted from the rocket to enhance the realism of the clip. The clip can also incorporate (as in display) the name (and address) of the launch site, and information about the launch (such as time of launch, flight time, launch location (e.g., the address where it launched), landing location (e.g., the address where it landed), etc.) The clip can be stored in any suitable format, such as AVI, MPG, etc.

From operation 3901, the method proceeds to operation 3902, which offers the user an option to post the media clip generated in operation 3901 on the user's social media account (e.g., FACEBOOK, etc.) A button can be presented to the user, to which if the user selects it (e.g., touches, clicks, etc.) then the system can automatically post the media clip to the user's social media account.

From operation 3902, the method proceeds to operation 3903, which determines whether the user opts to post the media clip to the user's social media account. If the user does not select the button to automatically post the clip, then the method proceeds to operation 3905, in which the medial clip is not automatically posted.

If in operation 3903, the user has selected the button, then the method proceeds to operation 3904, which automatically posts the media clip generated in operation 3901 to the user's social media account. The app may already know the user's social media credentials (e.g., login name and password) which could have been entered by the user during the registration process (when the user registered on the app). So the app can automatically log into the user's social media account using these credentials and then automatically post the media clip to the account.

In an embodiment, the app and/or server can track purchases made of rocketry equipment (e.g., rockets, engines, etc.) and also track launches of rockets. When the system determines that a user may need more of a particular type of engine, the user can automatically suggest to the user that the user purchase those needed engines.

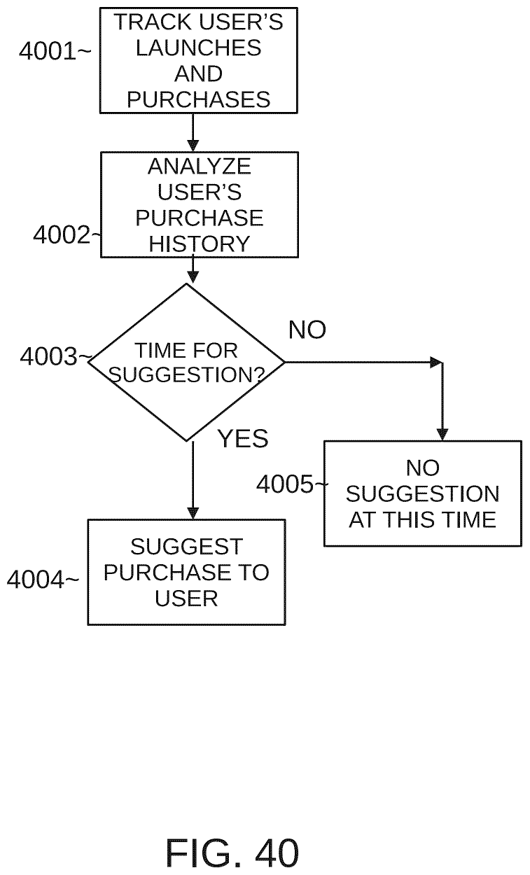

FIG. 40 is a flowchart illustrating an exemplary method of generating suggested purchases, according to an embodiment.

In operation 4001, the system can track user's purchases and launches. Each time a rocket is launched, the system would know the model rocket launched and also the engine used. In one embodiment, the user can enter into the app the model of the rocket being launched, and the app would know (via a lookup table or other method) which type of engine that that particular model rocket uses. In another embodiment, the launcher can have a camera or scanner and can determine the type of engine (e.g., either by optical recognition or by scanning a barcode on the engine). In another embodiment, the launcher can have a camera and visually recognize the model of rocket on the launcher, upon which the type of engine being used can then be determined. All types of optical/visual recognition described herein can be performed using any suitable method, such as using a convolutional neural network or other method. The system would store in a database, associated with the user's account, the model rocket being launched as well as the engine being used. This can be performed for each launch the user(s) performs. In this manner, the system would know the user's launch history (models launched, engines used, etc.)

From operation 4001, the method proceeds to operation 4002, which analyzes the user's purchase history. The analysis can also incorporate the user's launch history as well. For example, the number of particular engines (e.g., type C, type D, etc.) can be determined as well as the number of times those engines have been used in launches. The difference would then be the number of that type of engine the user would have on hand. For example, if the user purchased 10 type C engines, and launched 8 rockets using type C engines, the user would have 2 type C engines left. The analysis can also determine if the user has not purchased a new rocket in a predetermined amount of time (e.g., more than 3 months), which would then trigger a suggestion to buy a new model.

From operation 4002, the method proceeds to operation 4003, which determines whether it is time to make an automatic purchase suggestion to the user. If the user is low on a particular type of engine (for example, the number of a particular type of engines the user possesses is less than a predetermined threshold (e.g., 2) then the system could determine it is time to suggest the user purchase additional engines of those type. It can also be determined that the user must possess a model rocket that uses that type of engine, otherwise the user would not need new engines of those type and hence such a suggestion would not be made. For example, if the system determines that the user only has 2 model rockets that use engine type D, and no model rockets that use engine type C and the user only has 1 engine of type C, an automatic suggestion to purchase more type C engines would not be made because the user would have a rocket that uses type C. However, if this user has only 1 engine of type D, then an automatic suggest to purchase more type D engines would be made since the user only has 1 (less than a predetermined threshold) type D engine on hand. Note that in this scenario, the system could also suggest the user buy a new model rocket that uses type C engines since the user possesses some type C engines but does not have a rocket that utilizes type C engines. In operation 4003, the system would check a number of conditions to determine if any of the conditions are met to make an automatic suggestion. If none of these conditions are met, then the method proceeds to operation 4005, in which no automatic suggestion to make a purchase is made at this time.

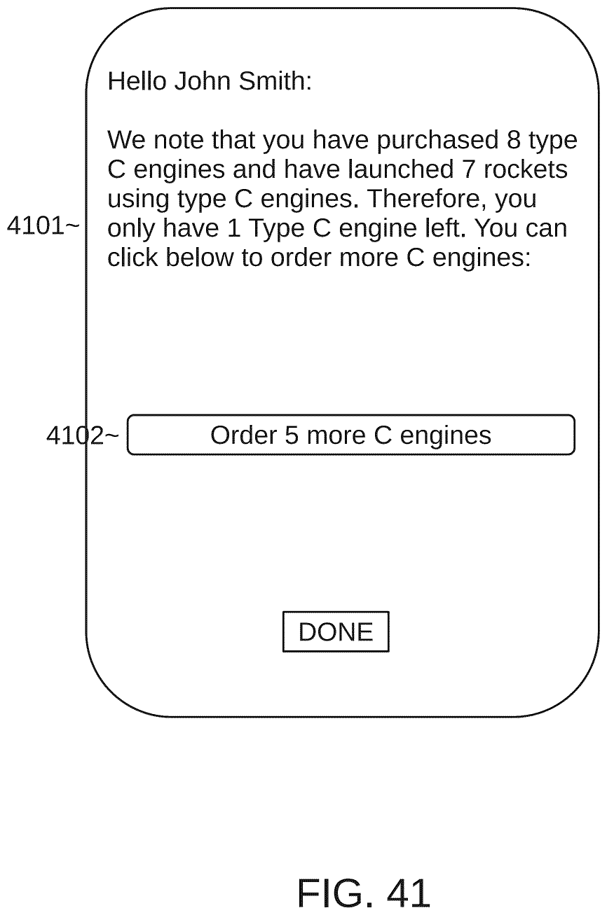

If in operation 4003, conditions are met to make an automatic purchase suggestion, then the method can proceed to operation 4004, which suggests a purchase to the user (for example see FIG. 41). The purchase can be suggested on an e-commerce platform (such as AMAZON), and/or an electronic storefront operated by a company that administers the app. The user can be presented with a link or button, that when selected (e.g., clicked, pushed, touched, etc.) would then automatically initiate the purchase.

FIG. 41 is a drawing of a sample screen of a mobile device displaying a suggested purchase, according to an embodiment.

A suggested purchase 4101 can be displayed which describes the suggested purchase. The suggested purchase can be a suggestion to purchase more engines, new model rockets, other supplies (e.g., parachutes, wadding, etc.). A purchase button 4102 can be displayed that when selected, would automatically make the purchase set forth in the suggested purchase 4101. The button can, once selected, for example, automatically order the suggested products and automatically pay for them (using payment information already stored in the user's account). Alternatively, the button can, once selected, put the suggested products in a shopping cart on an e-commerce site and the user would then have to continue to follow prompts on the e-commerce site in order to consummate the transaction (e.g., enter payment information, etc.)

In a further embodiment, the system can generate a media clip using information and assets about a recent rocket launch. This media clip can then be stored in the user's photo gallery, posted to a social network platform, etc.

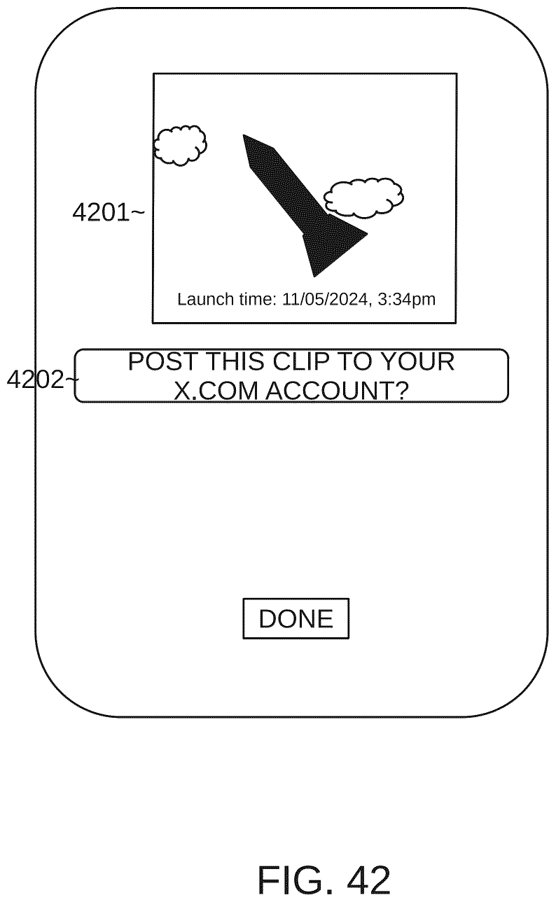

FIG. 42 is a drawing of a sample screen of a mobile device displaying a media clip, according to an embodiment.

A media clip 4201 can contain pictures or video captured from a camera located on the launcher, and/or the rocket, and/or the mobile phone running the app, etc. The video (or picture) can be of the rocket launching itself (taken by a camera on the launcher) and also pictures and/or video taken from the rocket itself (e.g., of the earth). The media clip 4201 can also be superimposed with textual information captured from the launch (and possibly sensors on the rocket), such as time and date of launch, location of launch, altitude of rocket, location of landing, length of flight, distance the rocket has travelled, speed of the rocket (or max speed), max altitude of the flight, etc.

An automatic post button 4202 can be displayed that when selected, would automatically post the media clip to the user's social media account (e.g., FACEBOOK, X.COM, etc.) where it can then be viewed by many other users of those social media platforms.

In a further embodiment, launch sites can be “crowd-sourced.” In other words, users can rate and review launch sites which can then be stored in a database for later retrieval and display by the system. In this manner, users can then specify certain criteria they are looking for in a launch site (e.g., location) and the system can then query the database (e.g., using a relationship database) and display compatible launch sites.

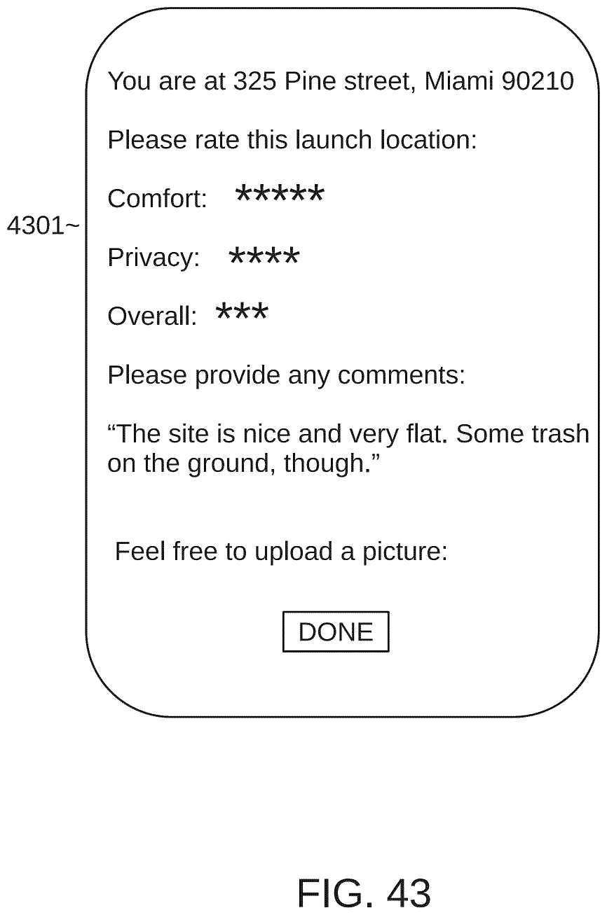

FIG. 43 is a drawing of a sample screen of mobile device displaying a review of a launch site, according to an embodiment.

When a user launches a rocket at a particular location (e.g., a launch site), the user can optionally post a review about that launch site. The review can include information such as its address (required), star ratings (e.g., comfort rating, privacy rating, overall rating, etc.), miscellaneous comments. The user can also upload pictures of the launch site. Launch review screen 4301 is one example of a review that a user has made about a particular launch site in order to help other users of the system find their own ideal launch site.

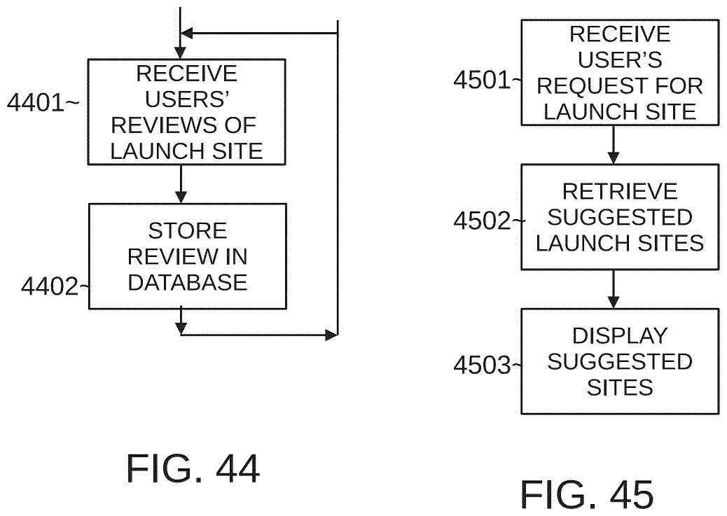

FIG. 44 is a flowchart illustrating an exemplary method of receiving reviews of launch sites, according to an embodiment.

When a user uses a launch site, the user can then review the site in the app. In an embodiment, the app would verify that the user actually performed a launch at that location before allowing the user to post a review about that launch site. The verification can be performed by using GPS data (from the mobile phone, and/or the launcher, and/or the rocket itself) to confirm that the user (and/or his/her equipment) was actually physically present in the boundaries of the launch site.

In operation 4401, the user would fill out a review form (such as that illustrated in FIG. 43) about the launch site. The user could optionally upload a picture of the launch site as well.

From operation 4401, the method can proceed to operation 4402, which would store the review in the database. Any type of relationship database can be used (e.g., SQL, etc.) so that the review can be easily stored, indexed, and retrieved as needed.

After reviews are stored in the database, they can be easily searched and retrieved, as needed by a user. Different users on the system would typically have access to all reviews placed by other users.

FIG. 45 is a flowchart illustrating an exemplary method of suggestion launch sites, according to an embodiment.

In operation 4501, a user would make a request on the app to display suitable launch sites. The request can include a zip code, address, or other location identifier identifying a location where the user wishes to find a launch site. The user can also indicate other preferences as well, such as a minimum size of the launch site (e.g., 2 acres), whether he wants an entirely private site, etc.

From operation 4501, the method proceeds to operation 4502, wherein the system retrieves suggested launch sites. For example, only sites that are with a threshold distance (e.g., 10 miles) from the desired location would be retrieved. The system would match other criteria as well (e.g., desired privacy, size, etc.)

From operation 4502, the method proceeds to operation 4503, which would display the suggested sites. All of the reviews for each suggested site can be displayed as well, so the user can read reviews for each potential launch site and determine which one he/she wants to use.

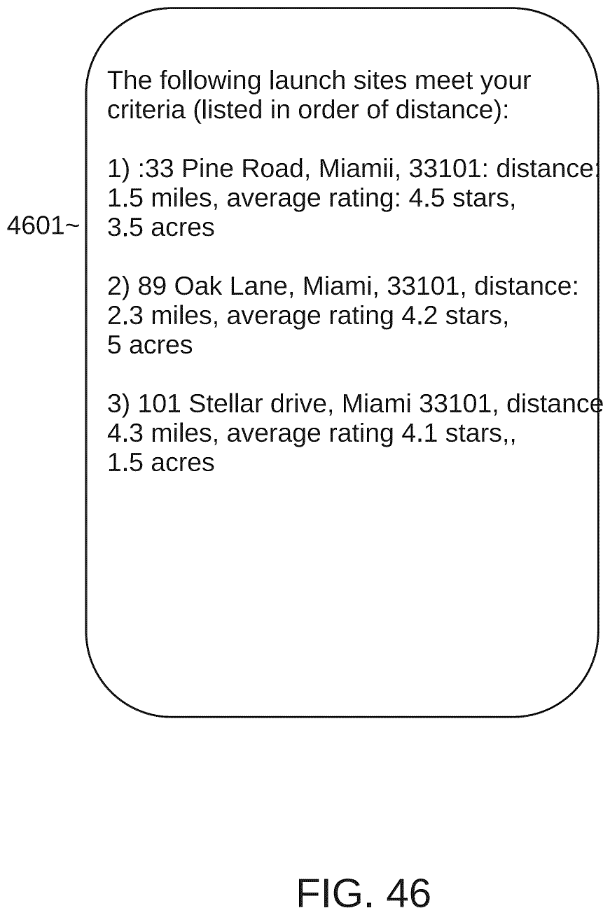

FIG. 46 is a drawing of a sample screen displaying suggested launch sites, according to an embodiment.

The app can prompt for and receive desired criteria for a launch site (e.g., an address for the ideal location, minimum size requirements, etc.) The app would then query the database and can display a list of suggested launch sites. The user can select any of the displayed launch sites to bring up additional information about them (e.g., photos, individual reviews, etc.)

In a further embodiment, the system can track launch data from multiple difference launches and store that data for later retrieval. For example, a user's all time highest altitude launch can be maintained. As another example, the system can maintain a public leaderboard displayed to all users of the users who have reached the highest altitudes (e.g., “top 10 highest flyers”).

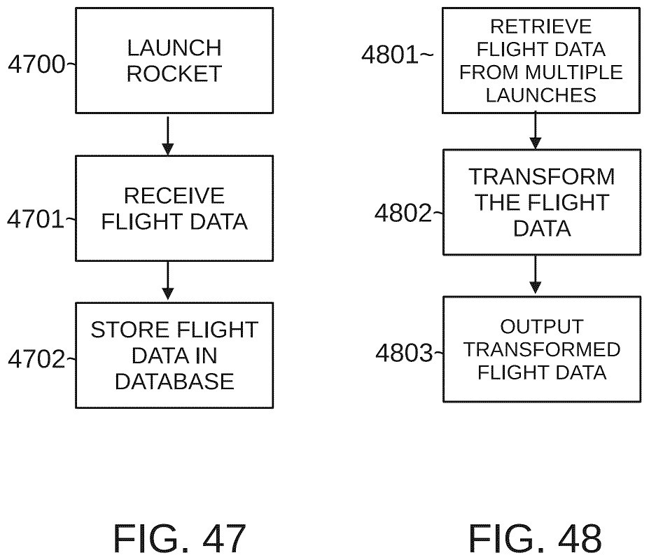

FIG. 47 is a flowchart illustrated an exemplary method of storing flight data across multiple launches, according to an embodiment.

In operation 4700, a rocket is launched. This can be performed as described herein.

From operation 4701, the method proceeds to operation 4702, which receives flight data from the rocket. The rocket can have on board a GPS module that determines its GPS coordinates (from the GPS satellites), sensors (altimeters, or any other sensors), etc. The processor on the rocket can continuously transmit this data on a periodic basis (e.g., every second). The data can be received by the app running on a mobile phone, and/or the launcher and/or a remote server. For example, the rocket can have a cellular data module attached to it so the data can be transmitted to a particular recipient (e.g., an IP address) over the standard cellular network. The recipient can be a server (e.g., server 1803) which stores all of this flight data. Note that all flight data from all launches can be stored from all users of the system.

As such, the method illustrated in FIG. 47 would conglomerate all launch data into a database so that the data can be curated and distributed as needed. For example, a leaderboard of the top 10 users who had their rockets achieve the highest altitudes can be publicized (e.g., posted on the app, published on social media, etc.) thereby generating publicity and friendly competition amongst the users of the system.

FIG. 48 is a flowchart illustrating an exemplary method of utilizing multiple flight data, according to an embodiment.

In operation 4801, the system can retrieve flight data from multiple launches. The flight data from all launches can be retrieved, or just selective launches. For example, all flight data obtained by a particular model of rocket can be retrieved (e.g., all flights from the “Big Bertha” model rocket). Or all flights launched in a particular state can be retrieved.

From operation 4801, the method proceeds to operation 4802, which transforms the flight data retrieved in operation 4801. The transformation would be based on the data desired. For example, if the system is determining all of the highest launch data, the transformation would be to return the 10 (or other number) of the flights with the highest maximum altitude. The transformation can also find net ground distance, which is the straight-line distance between the launch site and the final landing site on the ground, regardless of the rocket's flight path. It measures the rocket's horizontal travel from the point of launch to the point of landing. For example, if the rocket took off and landed at the same location, the net ground distance would be zero. The transformation can also find the total flight distance, which is the total distance the rocket travels along its flight path, considering both vertical and horizontal movement. It is the sum of all distances covered during ascent, descent, and any lateral movement. In your example, if the rocket ascended 1000 feet and then descended 1000 feet, the total flight distance would be 2000 feet, even though the net ground distance is zero.

Thus, the subset of rocket flights would be identified to retrieve (e.g., all flights of a particular model rocket), as well as the particular transformation applied to that data (e.g., take the average of the total flight distance for all those flights).

From operation 4802, the method can proceed to operation 4803, which would then output the transformed flight data. The transformed flight data can come in many forms. For example, a leaderboard can be displayed of the top users who have achieved the highest altitudes for each different model rocket (not combining the data from different models). As another example, the transformed flight data can be the largest net ground distance among all flights (or among particular rocket models). As another example, the transformed flight distance can be the highest total flight distance among all launches in a particular state. There can be no limit to the types of transformations that can be applied to the stored data. The data can be used for both marketing purposes (e.g., displaying leaderboard of the highest flights can garner publicity and public interest), as well as the data can be used for improving rocket design (if certain models of rockets do not achieve as high altitudes as other models of rockets, perhaps a redesign of the rocket can be in order).

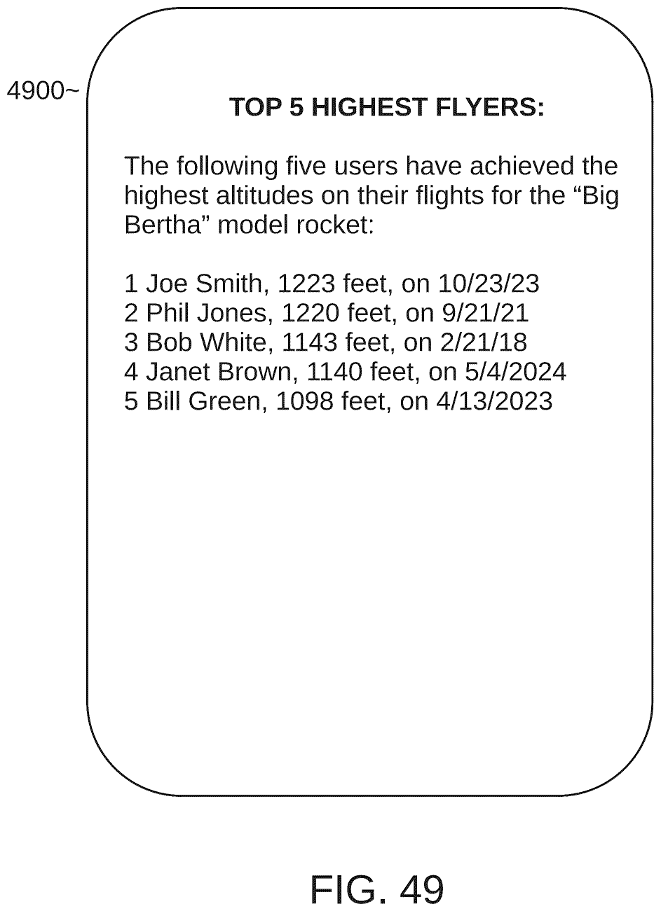

FIG. 49 is a drawing of a sample output of a leaderboard showing highest altitudes, according to an embodiment.

Leaderboard 4900 can be displayed on a mobile device or any other computing device. This is just one example of how the stored data can be transformed and displayed. This example displays the users who obtained the highest altitude (determined by the rocket's on board altimeter) for a particular model rocket. Such a leaderboard can be emailed to users, posted to social media, posted on a rocket manufacturer's web site, etc.

Note that such a leaderboard can be displayed of a particular user's own launches as well. So for example, a list of the top five altitudes for launches limited to a particular user can be displayed to that user as well,

Note that any features not illustrated and/or described herein which are necessary for the operation of any embodiments described herein can be considered inherently part of this disclosure. For example, all of the processors and related structures would have a suitable power supply (e.g., rechargeable battery) in order to power the electronic systems.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A model rocket launcher, comprising:
a launch pad;
a wireless interface configured to communicate wirelessly with at least one external device;
an electronic processing unit, the electronic processing unit connected to the wireless interface, wherein the electronic processing unit is configured to determine whether current continuity exists through two terminals, wherein the electronic processing unit is configured to transmit current through the two terminals upon receiving a signal from the wireless interface,
wherein the electronic processing unit is configured to transmit a status of the current continuity.

2. The launcher as recited in claim 1, further comprising:
an igniter connected between the two terminals.

3. The launcher as recited in claim 1, wherein the wireless interface is configured to communicate via Bluetooth or Bluetooth Low Energy.

4. The launcher as recited in claim 1, further comprising: an electronic output device connected to the electronic processing unit, the processing unit configured such that the electronic output device outputs a status of a launch.

5. The launcher as recited in claim 4, wherein the electronic output device comprises a set of LEDs.

6. The launcher as recited in claim 5, wherein the electronic processing unit is further configured such that when a status of the launcher is armed, a LED out of the set of LEDs is illuminated.

7. The launcher as recited in claim 4, wherein the electronic output device comprises a speaker.

8. The launcher as recited in claim 6, wherein the electronic processing unit is further configured such that when a status of the launcher is armed, an audible alert is triggered on the speaker.

9. The launcher as recited in claim 1, further comprising a keyhole and a key configured to fit inside the keyhole, wherein the electronic processing unit is configured to transmit a status of whether the key is inserted inside the keyhole.

10. The launcher as recited in claim 1, wherein the at least one external device is a mobile phone.

11. The launcher as recited in claim 1, wherein the electronic processing unit is further configured to: upon receiving a launch signal from the at least one external device, checking whether the launcher is in armed status, and only if so, then cause current to flow through the two terminals.

12. The launcher as recited in claim 1, wherein the current through the two terminals is at least one amp.

13. The launcher as recited in claim 1, further comprising a detector configured to detect an engine type of an engine located in a rocket on the launch pad.

14. The launcher as recited in claim 13, wherein the detector is a camera configured to read a barcode on the engine.

15. A model rocket launcher, comprising:
a launch pad;
a wireless interface configured to communicate wirelessly with at least one external device;
an electronic processing unit, the electronic processing unit connected to the wireless interface, wherein the electronic processing unit is configured to read and execute computer readable instructions from a non-transitory compute readable storage medium, the computer readable instructions, when executed, cause the electronic processing unit to: store a launch status, wherein the launch status is in a set comprising armed and not armed, and receive a command to launch via the wireless interface, wherein when the launch status is not armed then the processing unit will not trigger a current to initiate a launch, and when the launch status is armed then the processing unit will trigger a current to initiate the launch.

16. The launcher as recited in claim 15, further comprising a light, wherein the computer readable instructions are further programmed to cause the light to illuminate when the launch status is armed, and to not illuminate when the launch status is not armed.

17. The launcher as recited in claim 15, further comprising a speaker, wherein the computer readable instructions are further configured to cause the speaker to emit a sound when the launch status is changed from not armed to armed.

18. The launcher as recited in claim 15, further comprising a speaker, wherein the computer readable instructions are further configured to cause the speaker to emit a sound when a countdown before launch is occurring.

19. The launcher as recited in claim 15, further comprising a GPS locator, and the computer readable instructions are further configured to receive a location from the GPS locator and transmit the location to a mobile device or a remote sever.

20. A rocket, comprising:
a wireless interface;
a GPS locator device;
an electronic processing unit, the electronic processing unit connected to the wireless interface, wherein the electronic processing unit is configured to read and execute computer readable instructions from a non-transitory compute readable storage medium, the computer readable instructions, when executed, cause the electronic processing unit to:
receive GPS data from the GPS locator device and transmit the GPS data via the wireless interface;
repeat the receive and transmit, until a determination occurs which determines that the rocket has landed.

21. The rocket as recited in claim 20, wherein the determination that the rocket has landed is made using an altimeter.
